(19) United States
(12) Patent Application Publication
(10) Pub. No.: US 2024/0184527 A1
(43) Pub. Date: Jun. 6, 2024

(54) Apparatus and Method for Performing Arithmetic Operations

(71) Applicant: Finchetto Limited, London (GB)

(72) Inventors: Michael PEARCEY, London (GB); Mark RUSHWORTH, London (GB)

(73) Assignee: Finchetto Limited, London (GB)

(21) Appl. No.: 18/553,012

(22) PCT Filed: Mar. 30, 2022
(86) PCT No.: PCT/GB2022/050801

§ 371 Date: Sep. 28, 2023

(30) Foreign Application Priority Data
Mar. 31, 2021 (GB) 2104684-2

(51) Int. Cl. G06F 7/57

(52) U.S. Cl. CPC G06F 7/57

(57) ABSTRACT

Apparatus and Methods for performing arithmetic operations in a predetermined base and arithmetic logic units are provided. In one example, the apparatus comprises a non-linear medium. The apparatus further comprises one or more photon sources for outputting photons in a first frequency band and a second frequency band towards the non-linear medium, the first frequency band being representative of a first numeric value and the second frequency band being representative of a second numeric value. The apparatus further comprises an input to receive a signal indicative of at least one numeric value. The apparatus further comprises logic to select at least one of the first frequency band and second frequency band in dependence on the signal. The apparatus further comprises a detector configured to detect photons in a third frequency band that have been output from the non-linear medium in response to photons from at least one of the one or more photon sources in the at least one of the first frequency band and second frequency band being incident on the non-linear medium, the third frequency band representative of a third numeric value. The photons incident on the non-linear medium are subject to the non-linear phenomenon of the non-linear medium to perform an arithmetic operation on one or both of the first numeric value and the second numeric value to generate the third numeric value.

This present application provides disclosures relating to apparatus and methods for performing arithmetic operations, particularly apparatus utilising photonics to perform arithmetic operations.

### BACKGROUND

Current processors, also referred to as CPUs, are dependent on electronic transistors to operate, the electronic transistors controlling electron flow through the processor. For the past few decades, processors have been driven by Moore's Law, that suggests that the number of transistors incorporated in a chip will double about every two years. However, since 2016, Moore's law has slowed as the semiconductor industry approaches the fundamental limits of submicron miniaturization. As the number and variety of smart devices continues to increase, there is an increasing demand for more powerful processors without compromising on their size.

One fundamental aspect of a processor is an arithmetic logic unit (ALU). The ALU enables the CPU to perform arithmetic operations on binary numbers needed for the processor to operate. These arithmetic operations are the fundamental building blocks of a CPU and so the ALU is in constant use whist the CPU is in operation.

However, due to the semiconductor industry approaching the fundamental limits of submicron miniaturization, it is no longer as straightforward to reduce the size of an ALU and increase the speed and power of an ALU. Moreover, any further improvements are more complex which increases the likelihood of defects in manufacture. This consequently makes such CPUs unreliable. Moreover, any further improvements provide minimal improvements in processor power in comparison to their complexity, so the disadvantages of manufacturing complexity often outweigh the advantages of improvements in processor power.

It is in the above context that the present disclosure has been devised.

### BRIEF SUMMARY OF THE DISCLOSURE

Utilising photonics within CPUs and generally in electronic devices to define, manipulate, transfer and store data provides significant advantages over electrical signals: photons are extremely fast and can therefore transmit or process data in less time than the propagation delay of a regular electronic circuit; photons are controllable and so can be manipulated readily; photons require less energy to manipulate and so are more sustainable; and photons generate less heat, so are less likely to cause overheating resulting in performance constraints or component failure of a CPU. Therefore, to increase the speed and power of an ALU, the ALU may operate using photonic signals instead of or in addition to electrical signals. Arithmetic operations that were performed using electrical signals could therefore be performed using photonic signals, with the existing binary computing infrastructure being replicated but at least partially replaced with photonics, for example using optical transistors. This may increase the speed and sustainability of the ALU.

However, such an ALU does not provide a step-change in comparison to an existing electronic ALU, lacking flexibility due to its use of the existing binary infrastructure, and increasing cost and complexity by replacing novel photonic components like-for-like into well-established electronic component and system manufacture methods.

The present inventors have realised that replacing the existing ALU components with an apparatus as described herein that receives and utilises the properties of photonic signals would provide a flexible and versatile ALU. Such an ALU can perform a large variety of arithmetic operations to be used in general computing and can be tailored to specific use cases. This is because photonic signals have many unique properties such as frequency, wavelength, energy, phase, spin and polarization which are differentiable and can therefore be used to define and interpret data.

In particular, the present inventors have realised that performing the arithmetic operations by utilising the behaviour of the photonic signals in non-linear media would provide an apparatus that performs arithmetic operations at a high speed with low latency, at a low cost, at a low power and with a small device footprint due to the small number of components needed for such an operation to be performed. Using such an apparatus within an ALU of a CPU may increase the speed and reduce the cost, size and energy requirements of the CPU. Moreover, such an apparatus provides flexibility because it can be adapted to operate and perform arithmetic operations in any base.

Thus, according to an aspect of the invention an apparatus for performing arithmetic operations in a predetermined base is provided. The apparatus comprises a non-linear medium. The apparatus further comprises one or more photon sources for outputting photons in a first frequency band and a second frequency band towards the non-linear medium, the first frequency band being representative of a first numeric value and the second frequency band being representative of a second numeric value. The apparatus further comprises an input to receive a signal indicative of at least one numeric value. The apparatus further comprises logic to select at least one of the first frequency band and second frequency band in dependence on the signal. The apparatus further comprises a detector configured to detect photons in a third frequency band that have been output from the non-linear medium in response to photons from at least one of the one or more photon sources in the at least one of the first frequency band and second frequency band being incident on the non-linear medium, the third frequency band representative of a third numeric value. The photons incident on the non-linear medium are subject to the non-linear phenomenon of the non-linear medium to perform an arithmetic operation on one or both of the first numeric value and the second numeric value to generate the third numeric value.

The first and second frequency bands may be different and the first and second numeric values may be different.

At least one of the one or more photon sources may be configured to output photons in response to selection by the logic. Alternatively, the one or more photon sources may output photons continuously in use and the photons output by the one or more photon sources may be selectively propagated towards the non-linear medium in response to selection by the logic.

The detector may be configured to output an electrical signal representative of the third numeric value.

The one or more photon sources may comprise a first photon source for outputting photons in a first frequency band towards the non-linear medium and a second photon source for outputting photons in a second frequency band towards the non-linear medium. The majority of photons output from each photon source may be at a single frequency within the frequency band of the photon source.

The logic may be to select at least one of the first and second photon sources in dependence on the signal. The detector may be configured to detect photons in a third frequency band that have been output from the non-linear medium in response to photons from the at least one of the first and second photon sources being incident on the non-linear medium.

The number of photon sources selected by the logic to output photons may be based on the arithmetic operation.

The number of photon sources in the apparatus may correspond to the base of the arithmetic operations.

The photons output by the first photon source and the second photon source towards the non-linear medium may be combined into a single beam that is incident on the non-linear medium.

The apparatus may comprise at least one further photon source, each photon source for outputting photons in a different respective frequency band representative of a different numeric value towards the non-linear medium. The signal may be indicative of a further numeric value. The logic may be further configured to select a further photon source of the at least one further photon source based on the signal. The further photon source may be configured to output photons in response to selection by the logic.

The apparatus may further comprise a controller comprising the input and the logic, the controller configured to output one or more selection signals to only the one or more photon sources with output frequency bands corresponding to the at least one numeric value to output photons based on the logic.

The input of the controller may be configured to receive an electrical signal or a photonic signal indicating at least one numeric value to perform the arithmetic operation on.

The one or more selection signals may be electrical signals or photonic signals.

The apparatus may comprise a further photon source for outputting photons in a further frequency band different from the first and second frequency bands towards the non-linear medium, the further frequency band being representative of a fourth numeric value.

The photons incident on the non-linear medium may be subject to the non-linear phenomenon of the non-linear medium to perform an arithmetic operation on the fourth numeric value and one or both of the first and second numeric values to generate the third numeric value.

The first photon source may be further configured to output photons in a further frequency band different from the first and second frequency bands, the further frequency band being representative of a fourth numeric value. The logic may be to select one of the first frequency band and further frequency band of the first photon source.

The second photon source may be further configured to output photons in a second further frequency band different from the first, second and further frequency bands, the second further frequency band being representative of a fifth numeric value. The logic may be to select one of the second frequency band and second further frequency band of the second photon source.

The logic may be to select the frequency band of the first and second photon sources based on the numeric values required to perform the arithmetic operation.

The first frequency band and further frequency band of the first photon source may not overlap. The second frequency band and the second further frequency band of the second photon source may not overlap.

The one or more photon sources may comprise a first photon source for outputting photons in a first frequency band and a second frequency band towards the non-linear medium.

The number of frequency bands selected by the logic may be based on the arithmetic operation.

The first photon source may be for outputting photons in a number of frequency bands corresponding to the base of the arithmetic operations.

The photons output by the first photon source may be in a single beam that is incident on the non-linear medium.

The non-linear medium may be birefringent crystal. The non-linear medium may be Barium Borate or Lithium Niobate. The non-linear medium may be thin film Lithium Niobate. Lithium Niobate provides a reliable output with greater conversion efficiency. The non-linear medium may be doped, for example with magnesium, to improve conversion efficiency and protect the crystal from damage. The non-linear medium may be doped with zinc or titanium for improved performance characteristics.

Each of the one or more photon sources may be a laser, for example, a laser diode.

The frequency bands of the one or more photon sources may not overlap.

The majority of photons output in each frequency band may be at a single frequency within the frequency band.

The apparatus may further comprise a filter configured to receive the photons output from the one or more photon sources that have been output from the non-linear medium and to filter the photons such that only photons having a frequency within the third frequency band propagate through the filter to the detector.

The arithmetic operation may be one of adding, subtracting, multiplying, dividing shifting, a logical operation and bit manipulation. Such arithmetic operations are low level in that they can be determined at detector level. Low level arithmetic operations may be used as building blocks for more complex arithmetic operations such as exponentiation, percentages, logarithms and trigonometric functions. Complex arithmetic operations may utilise one or more low level arithmetic operations. Complex arithmetic operations may include further calculations in addition to the one or more low level arithmetic operations. These calculations may be implemented by a processor connected to the detector.

The arithmetic operation may be in a base of more than two.

Standard processors operate using a binary system, which has a base of two as a binary unit (also referred to as a bit) is either in a state of 0 or 1. This is because these processors use transistors, which have two states. Transistors are either on (represented by high current), typically indicating a bit of 1, or off (represented by a low current), typically indicating a bit of 0. However, using a binary system is inefficient as a large number of binary units is required to represent a large number. Due to a large number of binary units often being required, performing arithmetic operations on these units takes a long time and a large computing resource. Using a higher base number means that, for any individual piece of data, more entropy is conveyed. The higher the base, the higher the entropy. For example, a unit of base two can convey two states whereas a unit of base ten can convey ten states. Moreover, two units of base two can convey four states whereas two units of base ten can convey one hundred states, and thus more information. Therefore, it is advantageous to perform arithmetic operations on a base of more than two to maximise the efficiency of a computational system. Whilst this is not possible using transistors as they can only be reliably read in two states, the apparatus of the present invention can be used to perform arithmetic operations in a base of more than two. For example, each photon source or frequency band of the apparatus may provide a different state of a unit in the base. Such operations increase the efficiency and decrease the power usage of the apparatus and an ALU comprising the apparatus. Moreover, as there are more states per unit and therefore a higher number can be represented, the likelihood of requiring a carry bit, or carry unit, and consequently the carry rate, is reduced.

If the third numeric value is above the maximum numeric value allowable by the base, a carry bit, or carry unit, attached to the third numeric value may be set.

The arithmetic operation may be addition and the non-linear phenomenon may be sum frequency generation, SFG.

Viewed from another aspect, the present disclosure provides an arithmetic logic unit, ALU, comprising one or more apparatus as described herein.

At least two apparatus of the one or more apparatus may be for performing different arithmetic operations. The signal received at the input of each apparatus may be based on the type of arithmetic operation and the at least one numeric value.

The ALU may comprise a controller. The controller may be configured to receive at least one instruction signal indicating the type of arithmetic operation to be performed and the at least one numeric value to perform the arithmetic operation on. The controller may be further configured to output a signal to only the apparatus for performing the type of arithmetic operation.

The instruction signal may be an electrical signal or a photonic signal.

Two apparatus for performing the same arithmetic operation may be arranged in a cascade configuration such that the first photon source of the second apparatus is configured to output photons in the third frequency band representative of the third numeric value output from the first apparatus and the first photon source or the second photon source of the second apparatus is configured to output photons in a further frequency band representative of a fourth numeric value such that the arithmetic operation is performed on the fourth numeric value and one or both of the first and second numeric values.

Viewed from another aspect, the present disclosure provides a method for performing arithmetic operations in a predetermined base using a non-linear medium. The method comprises receiving a signal indicative of a first numeric value. The method further comprises selecting a first frequency band of a first photon source in dependence on the signal. The method further comprises outputting photons in the first frequency band from the first photon source towards the non-linear medium, the first frequency band being representative of the first numeric value. The method further comprises detecting photons in a third frequency band that have been output from the non-linear medium in response to photons from the photon source being incident on the non-linear medium, the third frequency band representative of a third numeric value. The photons incident on the non-linear medium are subject to the non-linear phenomenon of the non-linear medium that performs an arithmetic operation on the first numeric value to generate the third numeric value.

The signal may be further indicative of a second numeric value. The method may further comprise selecting a second frequency band of the first photon source or a second photon source in dependence on the signal. The method may further comprise outputting photons in the second frequency band from the first photon source or the second photon source towards the non-linear medium, the second frequency band being representative of the second numeric value. The method may further comprise detecting photons in a third frequency band that have been output from the non-linear medium in response to photons in both frequency bands being incident on the non-linear medium. The photons incident on the non-linear medium may be subject to the non-linear phenomenon of the non-linear medium that performs an arithmetic operation on the first numeric value and the second numeric value to generate the third numeric value.

The first and second frequency bands may be different and the first and second numeric values may be different.

The method may further comprise receiving a signal selecting at least the first and second numeric values to perform the arithmetic operation on and controlling only photon sources with output frequency bands corresponding to the at least first and second numeric values to output photons.

The number of photon sources controlled to output photons may be based on the arithmetic operation.

The received signal may be an electrical signal. The method may further comprise outputting an electrical signal indicating the third numeric value.

The method may further comprise outputting photons in a further frequency band from a further photon source towards the non-linear medium, the further frequency band being representative of a fourth numeric value. The photons incident on the non-linear medium may be subject to the non-linear phenomenon of the non-linear medium that performs an arithmetic operation on the first numeric value, second numeric value and fourth numeric value to generate the third numeric value.

The method may further comprise outputting one or more selection signals from a controller to only the one or more photon sources with output frequency bands corresponding to the at least one numeric value to output photons based on logic in the controller.

The method may further comprise receiving an electrical signal or a photonic signal indicating at least one numeric value to perform the arithmetic operation on.

The one or more selection signals may be electrical signals or photonic signals.

The number of photon sources selected to output photons may be based on the arithmetic operation.

The number of photon sources in the apparatus may correspond to the base of the arithmetic operations.

The apparatus may comprise a further photon source for outputting photons in a further frequency band different from the first and second frequency bands towards the non-linear medium, the further frequency band being representative of a fourth numeric value. The photons incident on the non-linear medium may be subject to the non-linear phenomenon of the non-linear medium to perform an arithmetic operation on the fourth numeric value and one or both of the first and second numeric values to generate the third numeric value.

The first photon source may be further configured to output photons in a further frequency band different from the first and second frequency bands, the further frequency band being representative of a fourth numeric value. The logic may be to select one of the first frequency band and further frequency band of the first photon source.

The second photon source may be further configured to output photons in a second further frequency band different from the first, second and further frequency bands, the second further frequency band being representative of a fifth numeric value. The logic may be to select one of the second frequency band and second further frequency band of the second photon source.

Selecting the first photon source and second photon source may comprise selecting the frequency band of the first and second photon sources based on the numeric values required to perform the arithmetic operation.

The first frequency band and further frequency band of the first photon source may not overlap. The second frequency band and the second further frequency band of the second photon source may not overlap.

The non-linear medium may be birefringent crystal.

Each photon source may be a laser diode.

The frequency bands of each photon source may not overlap with the frequency bands of the other photon sources.

The majority of photons output from each photon source may be at a single frequency within the frequency band of the photon source.

The method may further comprise filtering the photons that have been output by the non-linear medium such that only photons having a frequency within the third frequency band propagate through the filter for detection.

The arithmetic operation may be one of adding, subtracting, multiplying, dividing, shifting, a logical operation and bit manipulation.

The arithmetic operation may be in a base of more than two.

The method may further comprise setting a carry bit attached to the third numeric value if the third numeric value is above the maximum numeric value allowable by the base.

The arithmetic operation may be addition and the non-linear phenomenon may be Sum Frequency Generation. In some examples, to perform complex arithmetic operations, a plurality of non-linear media may be used, the output of each non-linear medium being input into the next non-linear medium.

Viewed from another aspect, the present disclosure provides a photonic control unit. The photonic control unit comprises a two-dimensional array of photonic elements having at least two rows and at least two columns. The photonic control unit further comprises a first refractor for receiving an instruction beam indicating an instruction and refracting the instruction beam into at least one row of the at least two rows based on a characteristic of the instruction beam. The photonic control unit comprises a second refractor for receiving a numeric value beam indicating a numeric value and refracting the numeric value beam into at least one column of the at least two columns based on a characteristic of the numeric value beam. The instruction beam and numeric value beam intersect at at least one photonic element, causing the photonic element to output a control signal indicating the instruction and the numeric value.

Viewed from another aspect, the present disclosure provides a system comprising an ALU described herein and a photonic control unit described herein.

A computer readable medium may comprise instructions which, when executed by a processor, cause the processor to perform methods of the controller described herein. A computer program and/or the code/instructions for performing such methods as described herein may be provided to a device, such as a computer, on a computer readable medium or computer program product. The computer readable medium could be, for example, an electronic, magnetic, optical, electromagnetic, infrared, or semiconductor system, or a propagation medium for data transmission, for example for downloading the code over the Internet. Alternatively, the computer readable medium could take the form of a physical computer readable medium such as semiconductor or solid-state memory, magnetic tape, a removable computer diskette, a random access memory (RAM), a read-only memory (ROM), a rigid magnetic disc, and an optical disk, such as a CD-ROM, CD-R/W or DVD.

Many modifications and other embodiments of the inventions set out herein will come to mind to a person skilled in the art to which these inventions pertain in light of the teachings presented herein. Therefore, it will be understood that the disclosure herein is not to be limited to the specific embodiments disclosed herein. Moreover, although the description provided herein provides example embodiments in the context of certain combinations of elements, steps and/or functions may be provided by alternative embodiments without departing from the scope of the invention.

### BRIEF DESCRIPTION OF THE DRAWINGS

Embodiments of the invention will now be described, by way of example only, with reference to the accompanying drawings, in which:

FIG. 1 provides a schematic diagram of an apparatus for performing arithmetic operations according to an example;

FIG. 2 provides example frequency distributions of the example apparatus of FIG. 1;

FIGS. 3A and 3B provide example illustrations of an example arithmetic operation;

FIG. 4 provides a schematic diagram of an apparatus for performing arithmetic operations according to another example;

FIG. 5 provides a schematic diagram of an apparatus for performing arithmetic operations according to another example;

FIG. 6 provides an example illustration of photon sources of an apparatus for performing arithmetic operations;

FIG. 7 provides an example truth table when the arithmetic operation is addition;

FIG. 8 provides a flowchart of a method for performing arithmetic operations according to an example;

FIG. 9 provides a flowchart of a method for performing arithmetic operations according to another example;

FIG. 10 provides a schematic diagram of an arithmetic logic unit according to an example;

FIG. 11 provides a schematic diagram of an arithmetic logic unit according to another example;

FIG. 12 provides a schematic diagram of an arithmetic logic unit according to another example;

FIG. 13 provides an example schematic diagram of the apparatus of the arithmetic logic unit of FIG. 12; and

FIGS. 14A and 14B provide schematic diagrams of an example photonic control unit.

FIGS. 15A and 15B illustrate example implementations of an example apparatus.

Throughout the description and drawings, like reference numerals refer to like parts.

### DETAILED DESCRIPTION

Whilst various embodiments are described below, the invention is not limited to these embodiments, and variations of these embodiments may well fall within the scope of the invention which is to be limited only by the claims.

The term “arithmetic operations” is to be understood to mean any operation on numeric values in a processor including standard arithmetic operations, logic operations, bit and bitwise operations and bitshift operations. For example, the arithmetic operation may be one of addition, subtraction, multiplication, division, shift, a logical operation and bit manipulation.

The term “numeric value” is interchangeable with the term “numerical value” and is to be understood to include at least an integer, a fraction, an imaginary number, a complex number, and a non-integer, for example, Pi. A numeric value may be a state, as discussed below in relation to bases.

Non-linear optics is the classic term for the branch of photonics that describes the behaviour of photons, in particular visible or near visible light, in non-linear media. However, it also applies to photon frequencies throughout the electromagnetic spectrum. For example, the input frequencies may be in the microwave range and/or the output frequencies may be in the infrared range.

The term “non-linear medium” is to be understood to mean any medium that causes a photonic signal incident on that medium to respond non-linearly. In particular, the polarisation density of a non-linear medium responds non-linearly to the electric field of the photons, as shown by the following equation, where P is polarisation density and E is electric field.

P=ε₀[X⁽¹⁾E+X⁽²⁾E+X⁽³⁾E+ . . . ]

X⁽¹⁾ E represents the linear polarization and the elements of the equation that follow represent the non-linear polarization, where X⁽²⁾ the is the second order non-linear susceptibility. The non-linear susceptibilities are small and therefore, if E is small, the non-linear elements of polarization can be ignored. However, when E is substantial, non-linear optics is prevalent. The electric field limit at which non-linear effects are expected is the Schwinger limit. Above the Schwinger limit, even a vacuum may be a non-linear medium. The non-linear medium may be a classical non-linear crystal, micro-spherical or nano-spherical formation or a GaAs film. An example non-linear medium is PPLN Crystal that is phase matched for sum frequency generation at 1550 nm C-Band wavelengths and accepts a bandwidth of around 24 nm.

The term “non-linear phenomenon” in relation to a non-linear medium is to be understood to mean the interaction of photons of incident beams with the non-linear medium. It is the consequence of the non-linear response of the incident photons to the non-linear medium. This may occur when the photons incident on the medium are of a high intensity, for example, the incident photons may have an electric field strength of 108 V/m, which is the typical strength provided by lasers. However, this may also occur when the photons are not at a high intensity, as optical non-linearities can be generated at individual photon to photon level. Thus, non-linear optics is not limited to high intensity signals. The apparatus described herein may use any non-linear phenomenon or phenomena.

An example of a non-linear phenomenon is Second Harmonic Generation. Second Harmonic Generation is an example of a 3-wave mixing process and involves the X⁽²⁾ term meaning it is a second order non-linearity. The process of the photons being subject to the non-linear phenomenon may be referred to as an N-wave mixing process, where N is the number of photonic waves involved. A 4-wave mixing process involves the X⁽³⁾ term meaning it is a third order non-linearity.

Photons being “subject to the non-linear phenomenon of the non-linear medium” is to be understood to mean the photons incident on the non-linear medium interact within the non-linear medium and respond in a non-linear way to the medium, as described above. Photons incident on a non-linear medium that are subject to the non-linear phenomenon are usually either manipulated when transmitting through the medium due to the non-linear phenomenon or are destroyed and new photons are generated based on the destroyed photons. For example, when the non-linear phenomenon is Sum Frequency Generation, incident photons of two different frequencies are destroyed and, as a result, photons at a frequency which is the sum of the two different frequencies is generated and output from the non-linear medium. The term “output from the non-linear medium” with reference to photons is therefore to be understood to mean photons have arrived from the non-linear medium after having interacted with the non-linear medium. For example, the photons may have been transmitted through the non-linear medium or may have been generated, and so originated from, within the non-linear medium.

A non-linear medium is not limited to only subjecting incident photons to one non-linear phenomenon, but may subject photons to one of many non-linear phenomena based on the conditions, for example, any electric fields present and the intensity, frequency and range of the input photons. Other conditions include temperature, angle of incidence on non-linear medium and size and direction of electromagnetic field. A non-linear medium may also simultaneously subject photons to more than one non-linear phenomenon.

The non-linear phenomenon that occurs due to the interaction between photons incident on the non-linear medium and the non-linear medium causes photons to be output from the non-linear medium that are different to those incident on the non-linear medium. For example, the photons output may have different properties to those input, such as one or more of frequency, polarisation, phase or path. This difference is based on the type of non-linear phenomenon that occurs and on the properties of the incident photons. Considering the property of frequency, the photons output from the non-linear medium are based on both the frequency of the incident photons and the type of non-linear phenomenon. Each frequency can be assigned a corresponding numerical value, such that that frequency represents the numerical value. Moreover, each type of non-linear phenomenon can be equated to an arithmetic operation. Therefore, the photons output from the non-linear medium, which have a frequency so represent a numerical value themselves, are based on the input numerical values and the arithmetic operation. Accordingly, the non-linear phenomenon effectively performs an arithmetic operation on numerical values to generate a resultant output of a numerical value. Where the relationship between frequencies of output photons and input photons of a non-linear medium due to a non-linear phenomenon is a relationship representative of an arithmetic operation, the non-linear phenomenon effectively performs that arithmetic operation. Different non-linear phenomena may effectively perform the same arithmetic operation. For example, Second Harmonic Generation and Third Harmonic Generation may effectively perform the same arithmetic operation of multiplication.

The term “base” is to be understood to mean the number of states a unit can be in. For example, for a base of two, also known as binary, a unit can only be in two states, such as a “0” and a “1”. For a base of three, also known as ternary, a unit can be one of three states such as a “0”, a “1” and a “2”. A “predetermined base” is to be understood to mean the base of the apparatus determined before the apparatus performs the operation. A base may be integer unsigned (for example, binary, ternary and quaternary), integer signed (for example, balanced ternary and balanced septemvigesimal), complex (for example, quarter-imaginary), non-integer (for example 0.5), or irrational (for example, ϕ, π and e). Integer signed, complex and non-integer bases enable more entropy to be conveyed for any individual piece of data. For example, for balanced ternary, which is signed, the states are “−1” (written as 1), “0” and “1”, a decimal “10” can be expressed as “101” and a decimal “−10” can be expressed as “101”. Binary can only represent positive decimal “10” and requires four bits to do so, the decimal “10” being “1010” in binary. Therefore, a reduced number of units is required to send the same information. Consequently, the use of balanced ternary improves processor speed and efficiency. Another base that is advantageous is hexadecimal, which has a base of sixteen. This base has the advantage that it can be used to natively compute pi (π) in near linear time and logarithmic space using the Bailey-Borwein-Plouffe (BBP) algorithm, as well as other constants using generalisations of BBP, for example Catalan's constant, π³, and π⁴. This base is also advantageous for use in photonic integrated circuits because the miniaturisation allows more components to be included in the photonic integrated circuit. Increasing the base provides an exponential relationship with non-linear efficiency for complex systems. A further base that is advantageous is senary, which has a base of six. This base is particularly useful for prime number manipulation since all prime numbers expressed in senary end in a “1” or a “5”.

The term “representative of a numeric value” is to be understood to mean that the photon source is transmitting the numeric value but within a particular frequency band. When this photonic signal is detected, it would be understood by a detector to indicate the numeric value. The relation between the frequency band and the numeric value may be unique to the apparatus or may be used throughout the ALU.

Whilst the term “frequency band” is used throughout the application and refers to a range of frequencies, each frequency band may have a peak intensity at a single frequency or within a small frequency range, such as 10 GHz, that is smaller than the frequency band, and so the majority of photons in the frequency band may be at that peak intensity or within the small frequency range. Where a particular frequency is provided in conjunction with a frequency band, for example ω₁, this frequency is within the frequency band and, if there is a peak intensity, this frequency is the peak intensity. For example, when photon sources output photons in a single frequency band, the majority of photons output from that photon source may be at a single frequency, indicated by ω₁, within that frequency band. Alternatively, this particular frequency may be within a small frequency range within the frequency band such that when photon sources output photons in a single frequency band, the majority of photons output from that photon source may be in the small frequency range within that frequency band. When photon sources output photons in two frequency bands, the majority of photons output from that photon source may be at two frequencies or frequency ranges, one within each frequency band. Where the term “frequency” is discussed, it is to be understood that such a term may mean a frequency band with a peak intensity at the frequency.

When discussing the transmission of light, which includes outputting and propagating photons and the transmission of photons through an optical path, this may be achieved, for example, using fibre optic cables between discrete components. Alternatively, this may be achieved by free optics, particularly for use in space. Alternatively, this may be achieved, for example, by routing through waveguides within a photonic integrated circuit. Where the apparatus is a photonic integrated circuit, this provides the following advantages:
(i) increased component density and ability to significantly increase total component number,
(ii) decreased power consumption,
(iii) standardized interoperability with external components, for example, through fibre coupling and electronic inputs and outputs,
(iv) standardized and high reliability components,
(v) consistent, stable component alignment and operation,
(vi) significantly smaller form factor,
(vii) ability to easily integrate different material platforms performing different operations, for example silicon photonics with III-V semiconductor materials,
(viii) cost-effective to manufacture in large volumes, and
(ix) lower photon intensity requirements, requiring less power, and higher efficiency components.

FIG. 1 provides a schematic diagram of an apparatus 100 for performing arithmetic operations according to an example. The arithmetic operations are performed in a predetermined base. The apparatus 100 comprises a non-linear medium 106. The apparatus 100 further comprises one or more photon sources for outputting photons in a first frequency band and a second frequency band towards the non-linear medium. FIG. 1 illustrates that the one or more photon sources of the apparatus 100 comprise a first photon source 102 for outputting photons 116 in a first frequency band towards the non-linear medium 106 and a second photon source 104 for outputting photons 118 in a second frequency band towards the non-linear medium, and the apparatus comprising the first and second photon sources will be described in detail below. However, the one or more photon sources of the apparatus 100 may instead comprise a single photon source for outputting photons in a first frequency band and a second frequency band towards the non-linear medium.

The first frequency band is representative of a first numeric value. The second frequency band is representative of a second numeric value. The apparatus 100 further comprises an input 112 to receive a signal 111 indicative of at least one numeric value. The apparatus further comprises logic 110 to select at least one of the first photon source 102 and second photon source 104 in dependence on the signal 111. The apparatus 100 further comprises a detector 108 configured to detect photons 120 in a third frequency band that have been output from the non-linear medium in response to photons from the at least one of the first and second photon sources 102, 104 being incident on the non-linear medium 106, the third frequency band representative of a third numeric value. The photons incident on the non-linear medium 106 are subject to the non-linear phenomenon of the non-linear medium 106 to perform an arithmetic operation on one or both of the first numeric value and the second numeric value to generate the third numeric value.

The apparatus 100 operates as follows. A signal 111 is received by the input 112 of the apparatus 100. Logic 110 in the apparatus 100 then receives the signal 111 and selects one or both of the first photon source 102 and second photon source 104 based on the numeric value indicated by the signal 111. The first photon source 102 outputs photons in a first frequency band and/or the second photon source 104 outputs photons in a second frequency band in response to being selected by the logic 110. The photons output from the first photon source 102 and/or second photon source 104 are incident on the non-linear medium 106 and are subject to the non-linear phenomenon of the non-linear medium 106 which outputs photons in a third frequency band. The frequency band of the photons output from the non-linear medium 106 is based on the frequency of the incident photons, which are in one or both of the first frequency band and the second frequency band. The frequency band of the photons output from the non-linear medium 106 is also based on the type of non-linear phenomenon the input photons are subject to. Each type of non-linear phenomenon may be equated to an arithmetic operation. Therefore, the frequency band of the output photons is effectively due to an arithmetic operation being performed on the photon in the first frequency band and/or the photon in the second frequency band. In response, the non-linear medium 106 effectively outputs photons in a third frequency band. As the first frequency band is representative of a first numeric value and the second frequency band is representative of a second numeric value, the non-linear medium 106 effectively performs an arithmetic operation on the first numeric value and/or second numeric value to generate a third numeric value, represented by the third frequency band. The detector 108 then detects the photons output from the non-linear medium 106 to determine the third numeric value.

The signal 111 at the input 112 of the apparatus 100 may indicate the photon source or photon sources to select and the logic 110 may select the photon source based on the indication. The signal 111 may indicate the numeric value or numeric values to perform the arithmetic operation on and the logic 110 may select the photon sources with the corresponding numeric values. The logic may be any circuitry for selecting at least one of the first photon source 102 and the second photon source 104 based on the received signal 111. The logic may comprise one or more logic gates. The logic may select the first and/or second photon source by powering on that photon source through sending a signal to that photon source, such that, if one of the photon sources is not selected by the logic, that photon source would not receive a signal and so would not power on and would remain off. The signal 111 may therefore be a power signal or an activation signal. The logic 110 may divert the signal 111 input into the apparatus 100 to the photon source that has been indicated or that's corresponding numerical value has been indicated by the signal. The logic 110 may be a demultiplexer that has an output for each respective photon source, the demultiplexer being arranged to receive the signal 111 at its input and route the signal to the output or outputs connected to the first and/or second photon source. Alternatively, the logic may be a connection between the photon sources and input 112 such that the photon sources both receive the signal. Alternatively, the logic 110 may be a controller that controls the first and second photon sources 102, 104. The controller may receive the signal 111 from the input 112 and power on or activate the first photon source 102 and/or the second photon source 104 based on the signal. The controller may convert the signal received from the input 112 into one or more selection signals. The controller may power on or activate the first photon source 102 and/or the second photon source 104 by sending a selection signal to the first photon source 102 and/or the second photon source 104. The selection signal may be an electrical signal or a photonic signal. The selection signal may be an AC signal or a DC signal.

The first photon source 102 and/or second photon source 104 may be provided with a signal from the logic 110 that causes it to output photons. Each photon source 102, 104 may be powered on and off separately by the logic 110 such that, when the photon source is powered on, it outputs photons and when the photon source is not powered on, it is off and does not output photons. In an example, the photon sources may be photonic-crystal surface-emitting lasers (PCSELs) that can be internally modulated such that the laser is only turned on when required, which reduces the power consumption of each laser. PCSELs can also have a small, for example 0.1 nm, channel spacing between their wavelength bands resulting in the non-linear medium only needing to operate in a small bandwidth. Therefore the non-linear medium can be fine-tuned to the small bandwidth and so more effectively converts the photon input frequencies to the photon output frequencies, resulting in a high conversion efficiency.

Alternatively, the first and second photon sources 102, 104 may output photons continuously in use and the photons output by the first and second photon sources may be selectively propagated towards the non-linear medium in response to selection by the logic. For example, the first and second photon sources 102, 104 may be always on in use and externally modulated, for example, the output of each photon source may be input into a separate switch (not shown), for example, a separate Mach-Zehnder modulator (MZM). The number of MZMs may equal the number of photon sources. Each photon source may output a continuous wave beam into an MZM. Each MZM may receive the signal 111 or a different signal from the logic 110 as a digital input signal to on/off key the output of the photon source. For example, the MZM may either propagate the output of the photon source or prevent propagation of the output of the photon source based on the signal 111. Thus, the MZM may be used to effectively switch on/off each photon source based on the signal 111. The inclusion of each MZM increases the switching speed of the apparatus 100, increasing the speed of an ALU including the apparatus 100.

The first photon source 102 is for outputting photons 116 in the first frequency band towards the non-linear medium 106. The first frequency band is representative of a first numeric value. Therefore, there is an association between the first frequency band and the first numeric value. As such, when photons having a frequency within the first frequency band are detected, they are related it to the first numeric value. For example, if the detector 108 was to receive photons having a frequency within the first frequency band, the detector 108 may associate this with the first numeric value and may therefore use or output the first numeric value.

The first photon source 102 may output the majority of photons 116 at a first frequency ω₁ within the first frequency band, as indicated in FIG. 1. The first photon source 102 may be arranged to output photons at the first frequency ω₁ within the first frequency band. Thus, the majority of photons output from the first photon source may be at the first frequency ω₁. However, due to other factors such as noise, the first photon source 102 may output photons at frequencies within the first frequency band differing slightly from the first frequency. The first frequency may be representative of the first numeric value. For example, there may be an association between the first frequency and the first numeric value. Data indicative of the association between the first frequency or first frequency band and first numeric value may be stored in the apparatus or in an ALU comprising the apparatus.

The second photon source 104 is for outputting photons 118 in the second frequency band towards the non-linear medium 106. The second frequency band may differ from the first frequency band and may not overlap with the first frequency band. Alternatively, the first frequency band and second frequency band may partially overlap. The second frequency band is representative of a second numeric value. Therefore, there is an association between the second frequency band and the second numeric value. As such, when photons having a frequency within the second frequency band are detected, they are related it to the second numeric value. For example, if the detector 108 was to receive photons having a frequency within the second frequency band, the detector 108 may associate this with the second numeric value and may therefore use or output the second numeric value.

The second photon source may output the majority of photons 118 at a second frequency ω₂ within the second frequency band, as indicated in FIG. 1. The second photon source 104 may be arranged to output photons at a second frequency within the second frequency band. Thus, the majority of photons output from the second photon source may be at the second frequency. However, due to other factors such as noise, the second photon source 104 may output photons at frequencies within the second frequency band differing slightly from the second frequency. The second frequency ω₂ may be representative of the second numeric value. For example, there may be an association between the second frequency and the second numeric value. Data indicative of the association between the second frequency or second frequency band and second numeric value may be stored in the apparatus 100 or in an ALU comprising the apparatus.

The first frequency ω₁ and second frequency ω₂ may be different. The first frequency band and second frequency band may overlap but the first frequency and second frequency may be different. Thus, the first and second numeric values may be different. The frequencies of photons output from the photon sources 102, 104 may be in the visible region or near-visible region of the electromagnetic spectrum.

The photon sources 102, 104 may output an intense light beam of photons. The photon sources may be electronically generated coherent photon sources. The photon sources may be laser diodes. The laser diodes may be tuneable. The laser diodes may be silicon laser diodes. The first photon source 102 may be a single frequency laser, wherein the majority of photons output from the single frequency laser are at the first frequency. The second photon source 104 may be a single frequency laser, wherein the majority of photons output from the single frequency laser are at the second frequency. The intensities of the first photon source 102 and second photon source 104 may be the same, for example, when the apparatus 100 uses the non-linear phenomenon of Sum Frequency Generation. Alternatively, the intensities of the first photon source 102 and second photon source 104 may be different, for example, when the apparatus 100 uses the non-linear phenomenon of

### Optical Parametric Amplification.

The photons in the first and/or second frequency bands that are incident on the non-linear medium 106 are subject to the non-linear phenomenon of the non-linear medium 106 and consequently photons are output from the non-linear medium 106 in a third frequency band. At least some of the photons output from the non-linear medium 106 are in the third frequency band which is representative of a third numeric value. The third frequency band may differ from the first and second frequency bands. The third frequency band may not overlap or may partially overlap with the first and second frequency bands.

The first photon source 102 may output the majority of photons 116 in a first frequency ω₁ within the first frequency band and the second photon source 104 may output the majority of photons 118 in a second frequency ω₂ within the second frequency band. As the frequency of the photons output from the non-linear medium 106 are dependent on the frequency of the photons incident on the non-linear medium 106, the majority of photons output from the non-linear medium 106 may therefore have a third frequency ω₃ within the third frequency band, the third frequency based on the first and/or second frequencies. The third frequency ω₃ may be representative of the third numeric value. The third frequency may be different to the first and second frequencies. Thus, the first, second and third numeric values may be different.

The photons output by the first photon source 102 and the second photon source 104 towards the non-linear medium may be combined into a single beam that is incident on the non-linear medium 106. For example, the apparatus 100 may further comprise a multiplexer (not shown). The multiplexer may be operable to combine the photons output from each photon source and propagate these through a single optical path (also known as a single beam). The combined photons transmitted through the single optical path may be output towards the non-linear medium and incident on the non-linear medium 106 such that the combined photons are subject to the non-linear phenomenon of the non-linear medium 106. Thus, the photons from each photon source are output towards the nonlinear medium 106. By utilising a multiplexer, only a single optical path needs to be positioned correctly to ensure that photons are incident on the non-linear medium, which simplifies apparatus construction and improves conversion efficiency as the non-linear medium can be tuned more effectively to the single beam. The multiplexer may be a wavelength-division multiplexer. For example, the multiplexer may be a dense-wavelength-division multiplexer (DWDM). Using a DWDM enables small channel steps as low as 0.4 nm.

In response to receiving the photons from the single optical path, the non-linear medium may output photons directly to the detector 108. Alternatively, the non-linear medium may output photons to a second non-linear medium (not shown) to perform down-conversion, for example, Half Harmonic Generation, on the photons. This is to reduce the frequency of the output of the non-linear medium to a frequency that is easier to process, for example, around 1500 nm. Thus, the apparatus 100 may further comprise a second non-linear medium. Another way for the apparatus 100 to perform down-conversion is to perform Difference Frequency Generation (DFG) with a value of a lower frequency. For example, if the first two frequency bands exist between 1540 and 1550 nm, sum frequency generation (SFG) produces a wavelength around 770-775 nm. To move this back into the previous bandwidth, a DFG between 1550 nm and the 770-775 nm beam can be used to produce a beam in the 1540-1550 nm range again.

The apparatus 100 may further comprise a demultiplexer (not shown). The demultiplexer may be a wavelength-division demultiplexer. For example, the demultiplexer may be a dense-wavelength-division demultiplexer. The demultiplexer may be operable to route the photons output from the non-linear medium, or from the second non-linear medium, into one or more detectors 108 based on the frequency of the photons. The photons input into the demultiplexer from the non-linear medium may be routed to the correct output of the demultiplexer based on their frequency. Each output of the demultiplexer may correspond to a different frequency or frequency band. For example, where photons in the third frequency band are output by the non-linear medium, these photons may be routed to the output of the demultiplexer that corresponds to the third frequency band. Where photons output from the non-linear medium are only in one frequency band, the photons will be routed to a single demultiplexer output. The apparatus 100 may further comprise a plurality of detectors 108 (not shown) such that there is a detector connected to each output of the demultiplexer. Each detector may therefore detect a particular frequency or frequency band. For example, where photons in the third frequency band are output by the non-linear medium, these photons may be routed to the output of the demultiplexer that corresponds to the third frequency band and incident on the detector connected to that output. Thus, each detector does not need to detect the frequency of the photons incident on the detector but simply needs to detect whether photons have been incident on the detector as any photons incident on the detector will be of the frequency or frequency band of the particular demultiplexer output. Thus, simple detectors can be used, such as photodiodes, which increases the speed of the apparatus 100. The presence of photons on a particular detector will therefore indicate a particular frequency band and thus a particular numeric value. The demultiplexer may comprise a plurality of outputs corresponding to the number of possible results of the arithmetic operations, i.e., the number of possible frequency bands output by the non-linear medium. The number of detectors may correspond to the number of outputs of the demultiplexer.

The apparatus 100 may further comprise an erbium doped fiber amplifier (EDFA) (not shown) or waveguide amplifiers for amplifying the power of the outputs from the photon sources, non-linear medium and/or second non-linear medium. For example, the apparatus 100 may comprise EDFAs or waveguide amplifiers before and after each non-linear medium to ensure there is sufficient optical power for detection by the one or more detectors 108.

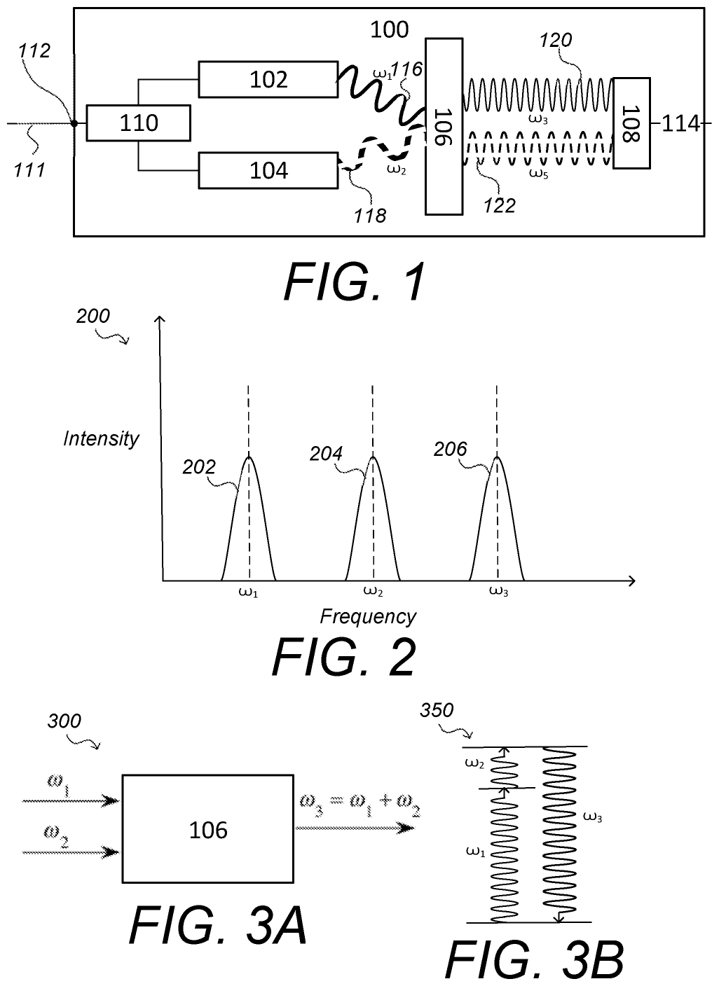

FIG. 2 provides example frequency distributions 200 of the example apparatus 100 of FIG. 1. FIG. 2 illustrates an example frequency distribution 202 of the photons output from the first photon source 102, an example frequency distribution 204 of the photons output from the second photon source 104 and an example frequency distribution 206 of the photons output from the non-linear medium 106. For all of the outputs, the signal is at its largest at a particular frequency, which means the majority of photons are at that frequency. Distribution 202 shows that all photons output from the first photon source 102 are in a first frequency band having upper and lower bounds and that the majority of photons are at the first frequency ω₁. Distribution 204 shows that all photons output from the second photon source 102 are in a second frequency band having upper and lower bounds and that the majority of photons are at the second frequency ω₂. Distribution 206 shows that photons output from the non-linear medium 106 are in a third frequency band having upper and lower bounds and that the majority of photons are at the third frequency ω₃. It is to be understood that this Figure is for explanation and the photon sources and non-linear medium are not limited to outputting such distributions.

Referring back to FIG. 1, whilst the apparatus 100 comprises the first photon source 102 and the second photon source 104, the logic 110 may select only one of the photon sources to output photons in dependence on the input signal 111. For example, the logic 110 may select that only the first photon source outputs photons 116, as illustrated by the dashed line of the photons 118 output from the second photon source, which indicates that such an output is optional. The logic 110 may alternatively select both of the photon sources 102, 104 to simultaneously output photons, meaning both the first photon source 102 and the second photon source 104 may output photons simultaneously towards the non-linear medium 106. The photons 116 output from the first photon source 102 and/or the photons 118 output from the second photon source 104 are incident on the non-linear medium 106.

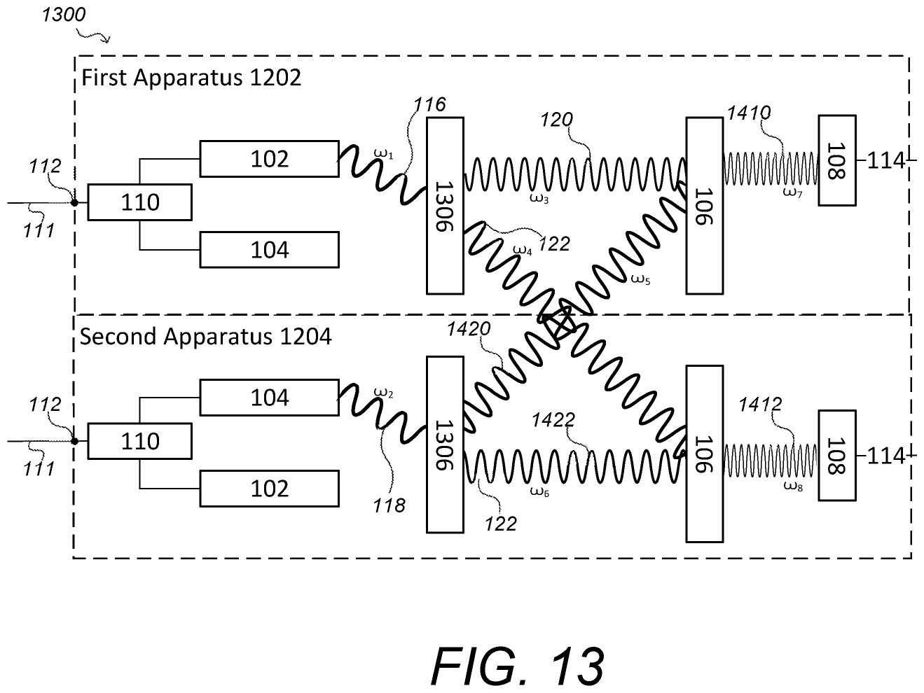

The photons incident on the non-linear medium 106 are subject to the non-linear phenomenon of the non-linear medium 106 to perform an arithmetic operation on one or both of the first numeric value and the second numeric value to generate the third numeric value, as explained in more detail below. Photons incident on the non-linear medium 106 that are subject to the non-linear phenomenon may be manipulated when transmitting through the medium due to the non-linear phenomenon or may be destroyed with new photons being generated based on the destroyed photons. The non-linear medium 106 may have a second order non-linearity. The non-linear medium 106 may be a birefringent crystal. The non-linear medium 106 may only be able to subject photons to one type of non-linear phenomenon and the apparatus 100 may use one non-linear phenomenon. Alternatively, the non-linear medium 106 may be capable of subjecting photons to a plurality of non-linear phenomena, either separately or simultaneously. The apparatus 100 may comprise a plurality of non-linear media. The apparatus 100 may use a plurality of different non-linear phenomena. Thus, the apparatus 100 may be for performing multiple different arithmetic operations, as described below in relation to FIG. 13.

If only the first photon source 102 outputs photons, the photons incident on the non-linear medium 106 are subject to the non-linear phenomenon of the non-linear medium 106 and consequently photons are output from the non-linear medium 106 in a third frequency band. The photons output in the third frequency band are the result of an arithmetic operation on the input photons in the first frequency band caused by the non-linear phenomenon. The first frequency band is representative of a first numeric value and the third frequency band is representative of a third numeric value. Therefore, the third numeric value is generated by an arithmetic operation on the first numeric value caused by the non-linear phenomenon.

If both photon sources 102, 104 simultaneously output photons, the photons output in the third frequency band is the result of an arithmetic operation on the input photons in the first frequency band and second frequency band caused by the non-linear phenomenon. Therefore, the third numeric value is generated by an arithmetic operation on the first numeric value and the second numeric value caused by the non-linear phenomenon.

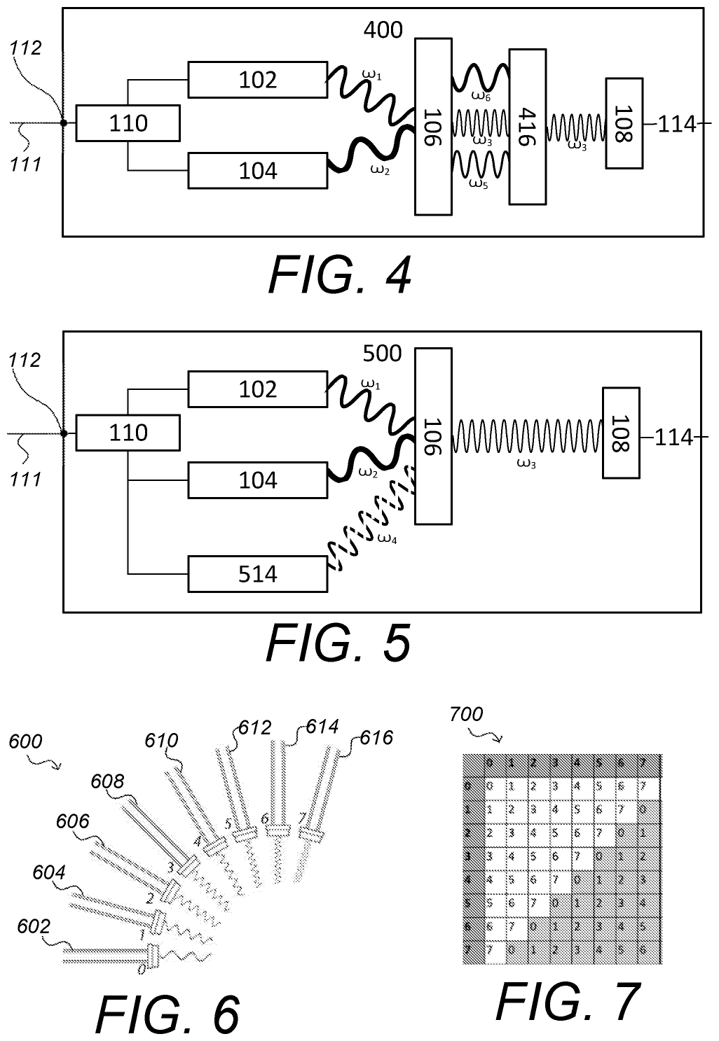

At least some of the photons 120 output from the non-linear medium 106 are in the third frequency band which is representative of the third numeric value. However, photons of other frequencies may also be generated. For example, photons 122 in a fifth frequency band or of the fifth frequency ω₅ different from the third frequency band may be output from the non-linear medium 106, as illustrated by the dashed line in FIG. 1, which indicates that such photons 122 are optional. These photons 122 may be desired in order to compute two numeric values. These photons 122 may be produced as a result of the interaction between the input photons and the non-linear phenomenon and the fifth frequency band may be representative of a fifth numeric value that is produced due to an arithmetic operation. In this case, the photons incident on the non-linear medium 106 may be subject to the non-linear phenomenon of the non-linear medium 106 to perform an arithmetic operation on one or both of the first numeric value and the second numeric value to generate the third numeric value and the fifth numeric value. Alternatively, the photons 122 having a frequency within the fifth frequency band or of the fifth frequency ω₅ may be caused by dispersion and other limitations such as walk off. Thus, these photons may be undesired. A filter may be used to remove these photons, as discussed further in relation to FIG. 4. Alternatively, if the majority of photons are in the third frequency band, the detector may be able to detect that this is the desired frequency band and remove the contribution of the other detected photons.

The detector 108 is configured to detect photons 120 in a third frequency band that have been output from the non-linear medium 106 in response to photons from the at least one of the first and second photon sources 102, 104 being incident on the non-linear medium 106. The detector 108 receives the photonic signal transmitted from the non-linear medium 106. The detector 108 receives photons in a third frequency band representative of a third numeric value and may consequently output 114 the third numeric value. The detector 108 may be configured to convert the photonic signal into an electrical signal and output 114 the electrical signal. The electrical signal may indicate the third numeric value. The detector 108 may be a CCD detector that converts an analogue light input from the non-linear medium 106 into a digital electrical output. The detector may output an electrical signal indicative of the third numeric value for storage and/or further manipulation. Alternatively, the detector may output 114 a photonic signal indicative of the third numeric value. Whilst one detector 108 is shown, apparatus 100 may comprise any number of detectors 108. For example, the apparatus 100 may comprise a detector 108 for each possible frequency to be detected.

The apparatus 100 may receive at its input 112 the signal 111 indicative of a first and second numeric value, may perform an arithmetic operation on the first and second numeric values to generate and output 114 the third numeric value. Alternatively, the apparatus 100 may only receive a first or a second numeric value and perform the operation on this value to generate the third numeric value. The apparatus 100 may therefore be used by an ALU comprising the apparatus 100 to perform a particular arithmetic operation on one or more numeric values. The apparatus 100 may be connected to electronic components and so may receive an electrical signal at its input and output an electrical signal. For example, the apparatus 100 may be connected to an electronic controller. Alternatively, the apparatus 100 may be connected to photonic components and so may receive a photonic signal at its input and output a photonic signal. For example, the apparatus 100 may be connected to a photonic controller. When the apparatus 100 is to output a photonic signal, the detector may be a photonic memory.

Each of the first and second photon sources 102, 104 may be a 3-state photon source. Thus, the photon source may be able to operate in the off state, a first state transmitting photons of a first frequency band and a third state transmitting photons in a frequency band different to the first frequency band. This different frequency band may be representative of a different numeric value. The logic 110 may therefore select the photon source and the frequency band of the photon source based on the numeric values indicated. Where the first and second photon sources are 3-state photon sources, an apparatus comprising the first and second photon sources may operate in a base of four as four different frequency bands may be utilised as inputs to the non-linear medium 106. Thus, an apparatus comprising one or more 3-state photon sources can perform a larger computation with a smaller number of components, improving efficiency and reducing the size of the apparatus.

One example of the non-linear phenomenon that the photons may be subject to that causes an arithmetic operation to be performed by the apparatus 100 is Sum Frequency Generation, as illustrated in FIGS. 3A and 3B. FIG. 3A illustrates a schematic diagram 300 of the non-linear medium 106 of FIG. 1 when the non-linear phenomenon is Sum Frequency Generation. FIG. 3B illustrates an energy level diagram 350 of photons incident on and output from the non-linear medium 106 when the non-linear phenomenon is Sum Frequency Generation. Sum Frequency Generation is a second order non-linear phenomenon in which the frequency of photons output from the non-linear medium 106 is the sum of the two input frequencies of photons incident on the non-linear medium 106. Thus, Sum frequency Generation effectively performs addition of two input frequencies or two representative numeric values. An apparatus 100 that performs addition using Sum Frequency Generation may be referred to as an Adder.

As shown in FIG. 3A, and as previously described in relation to FIG. 1, photons in a first frequency ω₁ are directed towards and incident on the non-linear medium 106 and photons in a second frequency ω₂ are directed towards and incident on the non-linear medium 106. The photons incident on the non-linear medium 106 are subject to the non-linear phenomenon of the non-linear medium 106, which in this case is Sum Frequency Generation, causing photons to be output from the non-linear medium 106 at a third frequency ω₃ which is the sum of the first and second frequencies, i.e. ω₃=ω₁+ω₂. In Sum Frequency Generation, to generate one photon at frequency ω₃, two input photons at frequencies ω₁ and ω₂ are simultaneously destroyed. The number of photons generated at the output is based on the number of input photons at each frequency. The non-linear phenomenon of Sum Frequency Generation therefore effectively adds the frequencies of the input photons and outputs a photon at the resultant frequency. When the photon frequencies represent numeric values, Sum Frequency Generation effectively performs the arithmetic operation of addition of the numeric values and outputs the result.

FIG. 3B shows an energy level diagram 350 that illustrates the energy levels input into and output from the non-linear medium 106. In non-linear photonics, two conservation laws apply, the conservation of energy and the conservation of momentum and these two laws are simultaneously called phase matching. Phase matching will be discussed below in relation to FIG. 4. The basic principle of the diagram 350 of FIG. 3 is that, to satisfy the conservation of energy law, total energy input into the non-linear medium 106 should be equivalent to total energy output from the non-linear medium 106 as energy is conserved. The energy of each photon is directly dependent on frequency, as E=hf. Therefore, the energy of each photon of a first frequency ω₁ incident on the non-linear medium 106 and the energy of each photon of a frequency ω₂ incident on the non-linear medium 106 combine to provide a total energy as illustrated by the top line of FIG. 3B. Each photon output from the non-linear medium 106 is at a frequency ω₃ which is the sum of the first and second frequencies so that the energy of each photon output from the non-linear medium 106 is equal to the combined energies of two photons at the first and second frequencies ω₁, ω₂ input into the non-linear medium 106.

Whilst FIG. 3B illustrates that the first frequency ω₁ and the second frequency ω₂ are different sizes and therefore different frequencies, these frequencies may be the same, for example both at a first frequency ω₁. Where these frequencies are the same, this is a special type of Sum Frequency Generation known as Second Harmonic Generation, which is another non-linear phenomenon that may be used by the apparatus 100. In Second Harmonic Generation, also known as frequency doubling, to generate one photon at frequency ω₃, two input photons at frequency ω₁ are simultaneously destroyed. Thus, Second Harmonic Generation causes photons to be output from the non-linear medium 106 at a third frequency ω₃ which is the double the first frequency. In the apparatus 100 of FIG. 1, this may occur when only one of the photon sources is transmitting, and consequently the photons of the same frequency are directed towards the non-linear medium or where the first and second photon sources output photons of the same frequency. Second Harmonic Generation effectively performs the arithmetic operation of multiplication by two of the input frequency or representative numeric value. An apparatus 100 for performing multiplication may therefore subject photons to Second Harmonic Generation and may be referred to as a multiplier. For Sum Frequency Generation and for Second Harmonic Generation, the non-linear medium 106 may be magnesium-doped lithium niobate crystal (MgO:PPLN).

Another example of the non-linear phenomenon that the photons may be subject to that causes an arithmetic operation to be performed by the apparatus 100 is Third Harmonic Generation that causes the destruction of three input photons of the same frequency to generate a photon with triple the frequency of the input photons. Thus, Third Harmonic Generation effectively performs the arithmetic operation of multiplication by three of the input frequency or representative numeric value. An apparatus 100 for performing multiplication may therefore subject photons to Third Harmonic Generation and may be referred to as a multiplier.

Another example of the non-linear phenomenon that the photons may be subject to that causes an arithmetic operation to be performed by the apparatus 100 is High Harmonic Generation that causes the destruction of any number of input photons which have the same frequency to generate a photon with a frequency significantly greater than the frequency of the input photons. The frequency of the generated photons may be 100 to 1000 times greater than the frequency of the input photons. Thus, High Harmonic Generation effectively performs the arithmetic operation of multiplication of the input frequency or representative numeric value by a large number such as 100 or 1000. For High Harmonic Generation, the non-linear medium 106 may be a ZnO crystal. The input frequency may be in the infrared range and the output frequency may be in the ultraviolet range.

Another example of the non-linear phenomenon that the photons may be subject to that causes an arithmetic operation to be performed by the apparatus 100 is Difference Frequency Generation (DFG) that causes the destruction of two input photons of different frequencies to generate a photon with a frequency that is the difference between the frequencies of the input photons. The number of photons generated at the output is based on the number of input photons. Thus, Difference Frequency Generation effectively performs the arithmetic operation of subtraction of the higher frequency from the lower frequency or of the representative numeric values. For Difference Frequency Generation, the non-linear medium 106 may be a PPMgLN crystal and the input frequencies may range from 400 nm to 3100 nm. The input frequencies may be in30 nm increments. An apparatus for performing subtraction may be referred to as a subtractor. An apparatus for performing subtraction may be used for other arithmetic operations such as a logical “AND” operation because, if the output provides a difference of “0”, the numerical values are the same so the result of the logical “AND” is TRUE or “1” in binary.

Another example of the non-linear phenomenon that the photons may be subject to that causes an arithmetic operation to be performed by the apparatus 100 is Optical Parametric Amplification. The non-linear medium 106 may receive input photons at a first frequency and input photons at a second, higher, frequency, which may also be referred to as the pump frequency. Optical Parametric Amplification causes the amplification of the photons with the first frequency using some of the power of the photons at the pump frequency and the generation of further photons at a different frequency, which may also be referred to as the idler frequency. The pump frequency is the combination of the first frequency and the idler frequency. Thus, Optical Parametric Amplification effectively performs the arithmetic operation of subtraction because the subtraction of the first frequency from the pump frequency produces the idler frequency. Therefore, Optical Parametric Amplification effectively performs subtraction on the representative numeric values of the pump frequency and the first frequency. For Optical Parametric Amplification, the non-linear medium 106 may be MgO doped PPLN crystal.

Another example of the non-linear phenomenon that the photons may be subject to that causes an arithmetic operation to be performed by the apparatus 100 is Optical Parametric Oscillation. The non-linear medium 106 may receive input photons at a first frequency, which may also be referred to as the pump frequency. Thus, for Optical Parametric Oscillation, only one photon source needs to be powered. Optical parametric oscillation causes the generation of photons at a signal frequency and at an idler frequency using a parametric amplifier in a resonator. The input pump frequency is the sum of the output signal frequency and idler frequency. Thus, Optical Parametric Oscillation effectively performs the arithmetic operation of subtraction because the subtraction of the idler frequency from the pump frequency produces the signal frequency. Therefore, Optical Parametric Amplification effectively performs subtraction on the representative numeric values of the pump frequency and the idler frequency. A non-linear medium 106 that subjects photons to Optical Parametric Amplification may be referred to as a decomposer, as explained below in relation to FIG. 13. For Optical Parametric Oscillation, the non-linear medium 106 may be MgO doped PPLN crystal.

Another example of the non-linear phenomenon that the photons may be subject to that causes an arithmetic operation to be performed by the apparatus 100 is Optical Parametric Generation that utilises the same inputs and produces the same outputs as Optical Parametric Oscillation but causes the generation of the photons using very high gain instead of a resonator. Optical Parametric Generation therefore effectively performs the same arithmetic operation as Optical Parametric Oscillation.

Another example of the non-linear phenomenon that the photons may be subject to that causes an arithmetic operation to be performed by the apparatus 100 is Half Harmonic generation. The non-linear medium 106 may receive input photons at a first frequency, which may also be referred to as the pump frequency. Half Harmonic generation is a particular type of Optical parametric Oscillation or Optical parametric Generation and so causes the generation of photons at a signal frequency and at an idler frequency using a parametric amplifier in a resonator. With Half Harmonic generation, the signal frequency and the idler frequency are the same and so the pump frequency is divided by two to produce the signal frequency and idler frequency. Thus, Half Harmonic generation effectively performs the arithmetic operation of division by two of the input frequency or of the representative numeric value.

Another example of the non-linear phenomenon that the photons may be subject to that causes an arithmetic operation to be performed by the apparatus 100 is Spontaneous Parametric Down Conversion. The non-linear medium 106 may receive input photons at a first frequency, which may also be referred to as the pump frequency. Spontaneous Parametric Down Conversion causes the conversion of each input photon into a photon at a signal frequency and a photon at an idler frequency through the amplification of the vacuum fluctuations in the low-gain regime. The number of photons generated at the output is based on the number of input photons. The input pump frequency is the sum of the output signal frequency and idler frequency. Thus, Spontaneous Parametric Down Conversion effectively performs the arithmetic operation of subtraction because the subtraction of the idler frequency from the pump frequency produces the signal frequency. Therefore, Spontaneous Parametric Down Conversion effectively performs subtraction on the representative numeric values of the pump frequency and the idler frequency. For Spontaneous Parametric Down Conversion, the non-linear medium 106 may be a ß-barium borate crystal.

Other examples of the non-linear phenomenon that the photons may be subject to that causes an arithmetic operation to be performed by the apparatus 100 are Optical rectification and Non-linear photon-matter interaction. For optical rectification, the non-linear medium 106 may be a lithium niobate LiNbO3 crystal.

The particular non-linear phenomena that the photons are subject to may depend on the type of non-linear medium 106 and the particular conditions of the apparatus, such as the angle and power of photons incident on the non-linear medium 106.

In an example, an adder (an apparatus 100 for performing addition) may have a non-linear medium 106 of a magnesium-doped lithium niobate crystal (MgO:PPLN), which is selected for its non-linear phenomenon of Sum Frequency Generation and Second Harmonic Generation. Such an adder may have, for example, ten photon sources with frequencies starting at 1500 nm (199,862 GHZ) and decreasing in successive increments of 70 nm to 870 nm (344,589 GHZ). Thus, the first photon source 102 may output photons at a frequency 199,862 GHz and the tenth photon source may output photons at a frequency 344,589 GHz. The photon sources may be of a higher intensity bracket, for example >2000 W/cm2. The magnesium-doped lithium niobate crystal is particularly effective at phase matching the above range. The output frequencies resulting from such input frequencies are in the near infrared to infrared range. The lowest frequency output would be the frequency of the first photon source doubled which is 399,724 GHz. The highest frequency output would be the frequency of the tenth photon source doubled which is 689, 178 GHZ.

By controlling the input angle of the photons incident on the non-linear medium 106, this enables control over the angle that the photons are output and the angle in which they are incident on the detector 108. For Sum Frequency Generation, the output may be read at between 1 and 10 degrees away from the normal. For Second Harmonic Generation, the output may be read at up to 30 degrees away from the normal.

As will be appreciated from FIG. 5, whilst two photon sources are shown and two numeric values are discussed, the apparatus 100 may comprise any number of photon sources, which may represent any number of numeric values and may operate in the same way as the first and second photon sources. The input 112 may therefore receive a signal 111 indicative of at least one numeric value of the numeric values and the logic may select any number of photon sources based on the signal 111. The photons from all the selected photon sources incident on the non-linear medium 106 are subject to the non-linear phenomenon of the non-linear medium 106 to perform an arithmetic operation on any number of numeric values to generate the third numeric value. The output wavelength range of the photon sources may be from 700 nm to 440 nm.

The apparatus 100 can be adapted to operate in any base by changing the number of photon sources. The number of photon sources in the apparatus 100 may be equal to the base of the arithmetic operations. Therefore, as the apparatus 100 comprises two photon sources, it may operate in the base of two, also known as binary, so may represent states “0” and “1”. Therefore, when the apparatus 100 is for performing arithmetic operations in a base of two, the first frequency band or first frequency output by the first photon source 102 may be representative of the state “0” and the second frequency band or second frequency output by the second photon source 104 may be representative of the state “1”.

The signal 111 received by the input 112 of the apparatus 100 may indicate one or both of the states “0” and “1”, for example, the signal may indicate state “0”. Based on this signal, logic 110 selects the first photon source 102, that corresponds to state “0”. The first photon source 102 outputs photons in the first frequency band in response to being selected by the logic. The photons output from the first photon source 102 are incident on the non-linear medium 106 and are subject to the non-linear phenomenon of the non-linear medium 106. Where the apparatus 100 is for performing the arithmetic operation of bit inversion, the non-linear phenomenon may be Optical Rectification and causes the destruction of two photons having a frequency within the first frequency band to generate a photon having a frequency within the third frequency band which is either a femtosecond pulse or a THz pulse beam. The detector 108 then detects the photons output from the non-linear medium 106 having a frequency within the third frequency band which represents the third numeric value, which in this example would be the inversion of 0 which is 1. The detector can then output the third numeric value of 1. Inversion may be used, for example, to apply one's complement to change a positive numeric value to a negative numeric value or vice versa. Inversion may also be used to apply two's complement by inverting and then adding “1” to the inverted output, for example, using an apparatus 100 for performing addition.

As mentioned above, whilst the apparatus 100 has been described above as having two photon sources to output photons in a first and second frequency band, the one or more photon sources of the apparatus 100 may alternatively comprise only a first photon source, i.e., a single photon source, to output photons in a first and second frequency band towards the non-linear medium. The photons output by the first photon source may be in a single beam that is incident on the non-linear medium. Thus, where the description refers to two or more photon sources for outputting photons in a plurality of frequency bands, this may be replaced with a single photon source for outputting photons in a plurality of frequency bands. The single photon source may be configured to output photons in any number of frequency bands, for example eight or sixteen frequency bands. The single photon source may be for outputting photons in a number of frequency bands corresponding to the base of the arithmetic operations. The logic may be to select whether the single photon source outputs photons in at least one of the first frequency band and second frequency band in dependence on the signal. As discussed above in relation to two photon sources, the single photon source may be powered on and off or instructed to output particular frequency bands by the logic 110 or may be always outputting photons in one or more frequency bands and externally modulated by a switch or filter controlled by the logic 110 that receives the photons output from the photon source and either propagates or restricts photons of one or more of the frequency bands. The number of frequency bands selected by the logic may be based on the arithmetic operation.

An example single photon source to output photons in a first and second frequency band is an optically pumped continuous wave soliton frequency comb laser, which can produce a range of wavelength outputs, for example 1450 nm to 1650 nm over 0.8 nm steps, from a single pump CW laser. For example, the laser may be capable of producing 256 different frequencies within a single beam. Providing a single photon source for outputting a single beam comprising photons in multiple frequency bands reduces the size of the apparatus and improves conversion efficiency as the non-linear medium can be tuned more effectively to the single beam.

In fact, the first and second photon sources and any further photon sources of any apparatus described in the specification may be replaced with a single photon source to output photons in at least a first and second frequency band towards the non-linear medium.

FIG. 4 provides a schematic diagram of an apparatus 400 for performing arithmetic operations according to another example. The arithmetic operations are performed in a predetermined base. The apparatus 400 is based on the apparatus 100 of FIG. 1. The apparatus 400 comprises the same components as the apparatus 100 of FIG. 1. The apparatus 400 also comprises a filter 416.

To optimise phase matching, the non-linear medium 106 may be a birefringent crystal. This optimises the phase matching condition because birefringent crystals have different refractive indexes for different polarisations. This means the crystal can be rotated to tune the polarisations in order to achieve phase matching. Another way to optimise phase matching is to perform angle tuning where photon sources 102, 104 may be positioned relative to the non-linear medium 106 such that the highest density of photons in the third frequency band are produced. The position of the photon sources may be controlled so that the angle of the beam input on the non-linear medium 106 is controlled. Tuning the angle of each photon source based on the wavelength of the photons output by that photon source increases conversion efficiency within the non-linear medium. Other ways to optimise phase matching are temperature tuning, quasi-phase matching and using a photonic filter such as filter 416 to filter the output from the non-linear medium 106 for the desired wavelength.

Whilst photons 120 output from the non-linear medium 106 have a frequency within the third frequency band which is representative of the third numeric value, photons of other frequencies may also be generated. For example, photons of a fifth frequency ω₅ and photons of a sixth frequency ω₆ may be output from the non-linear medium 106, as illustrated in FIG. 4, the fifth and sixth frequencies being different to the third frequency. The fifth and sixth frequencies may not be within the third frequency band. The photons of the fifth frequency ω₅ and/or of the sixth frequency ω₆ may be caused by dispersion and other limitations such as walk off. These photons are undesired. The filter 416 receives the photons output from the non-linear medium 106 and only enables the transmission of photons of the desired third frequency ω₃ or within the third frequency band through the filter 416, stopping the photons of other frequencies from being transmitted through. Thus, the filter 416 filters out the undesired fifth frequency ω₅ and sixth frequency ω₆ leaving the third frequency propagating through the filter 416. This results in the detector only receiving photons of the desired third frequency ω₃ or third frequency band. The detector 108 can then determine the third numeric value from the received photons in the third frequency or third frequency band ω₃.

The filter 416 may filter photons above a particular frequency and below a particular frequency. The filter may be a band pass filter, which only transmits photons within a given frequency range or band. The filter may be a long pass filter, which filters photons having frequencies above a given frequency. The filter may be a short or low pass filter, which filters photons having frequencies below a given frequency. For example, a short pass filter may ensure the photons having frequencies equal to the input frequencies are filtered out. The short pass filter may have a cut off wavelength of more than 700 nm and less than 870 nm, the cut off wavelength being based on the input wavelengths.

FIG. 5 provides a schematic diagram of an apparatus 500 for performing arithmetic operations according to another example. The arithmetic operations are performed in a predetermined base. The apparatus 500 is based on the apparatus 100 of FIG. 1. The apparatus 500 comprises the same components as the apparatus 100 of FIG. 1. The apparatus 500 may also comprise the filter 416 of FIG. 4 in some embodiments. The apparatus 500 further comprises a third photon source 514 for outputting photons in a fourth frequency band ω₄ representative of a fourth numeric value. The first photon source 102, second photon source 104 and third photon source 514 may all simultaneously output photons towards the non-linear medium 106. Alternatively, the logic 110, which may be a controller, may select one or two of the first photon source 102, second photon source 104 and third photon source 514 to output photons. The selection by the logic has been described in relation to FIG. 1 and applies to any number of photon sources. Whilst the apparatus 500 of FIG. 5 comprises the first photon source 102, second photon source 104 and third photon source 514, the apparatus 500 may comprise any number of photon sources, as described above in relation to FIG. 1 and below in relation to FIG. 6. For example, as described in relation to FIG. 1, the apparatus 500 may comprise a single photon source for outputting photons in a plurality of frequency bands, for example, a first frequency band, a second frequency band and a fourth frequency band and the logic may select photons from one or two of the frequency bands to propagate or for the single photon source to output.

The first photon source 102 outputs photons in a first frequency band, the second photon source 104 outputs photons in a second frequency band and the third photon source 514 outputs photons in a fourth frequency band. The first, second and fourth frequency bands may not overlap. Alternatively, the first, second and fourth frequency bands may partially overlap. The first photon source 102 may output photons substantially at a first frequency ω₁ within the first frequency band, the second photon source 104 may output photons substantially at a second frequency ω₂ within the second frequency band and the third photon source 102 may output photons substantially at a fourth frequency ω₄ within the fourth frequency band. The first, second and fourth frequencies may be different. As each frequency may be representative of a numerical value, the numerical values represented by the first, second and fourth frequencies may be different

The number of photon sources in the apparatus 500 may correspond to the base of the arithmetic operations. Therefore, as the apparatus 500 comprises three photon sources, it may operate in the base of three. As mentioned above, for a base of three, also known as ternary, a numeric value can be represented by three states, a “0”, a “1” and a “2”. Therefore when the apparatus 500 is for performing arithmetic operations in a base of three, photons within the first frequency band or at the first frequency output by the first photon source 102 may be representative of the state “0”, photons within the second frequency band or at the second frequency output by the second photon source 104 may be representative of the state “1” and photons within the fourth frequency band or at the fourth frequency output by the second photon source 104 may be representative of the state “2”.

The signal 111 received by the input 112 of the apparatus 500 may indicate one or more of the states 0, 1 and 2, for example, the signal may indicate states 0 and 1. Based on this signal, logic 110 selects the first photon source 102, that corresponds to unit 0, and the second photon source 104, that corresponds to unit 1. The first photon source 102 outputs photons in a first frequency band and the second photon source 104 outputs photons in a second frequency band in response to being selected by the logic. The photons output from the first photon source 102 and second photon source 104 are incident on the non-linear medium 106 and are subject to the non-linear phenomenon of the non-linear medium 106. Where the apparatus 500 is for performing the arithmetic operation of addition, the non-linear phenomenon is Sum Frequency Generation and destroys a photon in the first frequency band and a photon in the second frequency band to generate a photon in a third frequency band. The frequency of the photon in the third frequency band is the sum of the frequency of the photon in the first frequency band and the frequency of the photon in the second frequency band. The detector 108 then detects that the photons output from the non-linear medium 106 have a frequency within the third frequency band which represents the third numeric value, which in this example would be the addition of “0” and “1” which is “1”. The detector then outputs the third numeric value of “1”.

The three photon sources illustrated in FIG. 5 may be used to implement balanced ternary, which has a base of three. When the apparatus implements balanced ternary, the first photon source 102 may represent “1”, the second photon source 104 may represent “0” and the third photon source 514 may represent “1”

The apparatus 500 of FIG. 5 or the apparatus 100 of FIG. 1 may comprise eight photon sources, as illustrated in FIG. 6. FIG. 6 provides an example illustration of photon sources 600 of an apparatus for performing arithmetic operations. Each of the photon sources 600 illustrated in FIG. 6 outputs photons at a different frequency or in a different frequency band, as shown by the differing waves output from each photon source 602, 604, 606, 608, 610, 612, 614, 616. The output frequency or frequency band from each photon source may be representative of a numeric value.

The number of photon sources in the apparatus may be equal to the base of the arithmetic operations. Therefore, an apparatus comprising the eight photon sources of FIG. 6 may operate in a base of eight, which has states “0”, “1”, “2”, “3”, “4”, “5”, “6” and “7”. Photon source 602 outputs photons at a frequency or in frequency band which is representative of the state “0”. Photon source 604 outputs photons at a frequency or in a frequency band which is representative of the state “1”. Photon source 606 outputs photons at a frequency or in a frequency band which is representative of the state “2”. Photon source 608 outputs photons at a frequency or in a frequency band which is representative of the state “3”. Photon source 610 outputs photons at a frequency or in a frequency band which is representative of the state “4”. Photon source 612 outputs photons at a frequency or in a frequency band which is representative of the state “5”. Photon source 614 outputs photons at a frequency or in a frequency band which is representative of the state “6”. Photon source 616 outputs photons at a frequency or in a frequency band which is representative of the state “7”. The frequencies output by each photon source may increase as the representative state increases. Thus, photon source 602 may output a low frequency whilst photon source 612 may output a higher frequency.

When the photon sources 600 of FIG. 6 are used in an apparatus as described herein, the signal 111 received by the input 112 of the apparatus may indicate one or more of the states “0”, “1”, “2”, “3”, “4”, “5”, “6” and “7”, for example, the signal may indicate states “2” and “5”. Based on this signal, logic 110 selects the photon source 606, that corresponds to state “2”, and the photon source 612, that corresponds to state “5”. This may mean power is only applied to photon sources 606 and 612. The photon source 606 outputs photons towards the non-linear medium 106 at a frequency or in a frequency band corresponding to state “2” and the photon source 612 outputs photons towards the non-linear medium 106 at a frequency or in a frequency band corresponding to state “5” in response to being selected by the logic.

The photons output from the photon sources are incident on the non-linear medium 106 and are subject to the non-linear phenomenon of the non-linear medium 106. Where the apparatus is for performing the arithmetic operation of subtraction, the non-linear phenomenon is Difference Frequency Generation. Difference Frequency Generation causes the destruction of a photon of each frequency to generate a photon in a third frequency band, the generated photon having a frequency that is the difference between the frequencies of the input photons. The detector 108 then detects that the photons output from the non-linear medium 106 have a frequency within the third frequency band which represents the third numeric value, which in this example would be the subtraction of “2” from “5” which is “3”. The detector can then output the third numeric value of “3”.

FIG. 7 provides an example truth table 700 when the arithmetic operation is addition. This truth table is for a base of eight. It illustrates input numeric values in the left most column and top most row and the output numeric values in the remaining cells. The output numeric values illustrated are based on the input numeric values when the apparatus is for performing addition in the base of eight. The unshaded cells are when the output numeric value can be represented by a single output unit in the base of eight. For example, when the inputs are the numeric values “3” and “4”, the output numeric value is “7” which is one of the states of the base 8 and so can be represented by a single output unit in the base of eight. The shaded cells are when the output numeric value cannot be represented by a unit in the base of eight and so a carry unit is set. For example, when the inputs are the units “5” and “4”, the output numeric value is 9 which is not one of the states of the base 8 and so cannot be represented by the base of eight. This is because the result “9” is above the maximum numeric value allowable by the base. When this occurs, a carry unit, which may be a carry bit, attached to the unit may be set or incremented. For example, for the resultant value 9, a carry unit may be set or incremented, indicating that the output numeric value is over the maximum numeric value, and the output unit is then set to the number above the maximum value, which for the resultant value 9 is 2. Thus, the output numeric value may consist of an output unit of “2” and a carry unit of “1”. When the output unit and carry unit are detected, it is understood to mean the value 7 (provided by the carry unit) added to the output unit 2, which gives the result of 9. If detector 102 of the apparatus detects a third numerical value that is above the maximum numerical value allowable by the base, the detector can route the output can set a flag or send a signal indicating the carry unit in addition to sending the signal indicating the output unit. If the maximum numeric value allowable by the base is reached and the carry unit is set, a second carry unit may be set or the carry unit may be incremented to “2” and the output unit is then set to the number above the maximum numeric value.

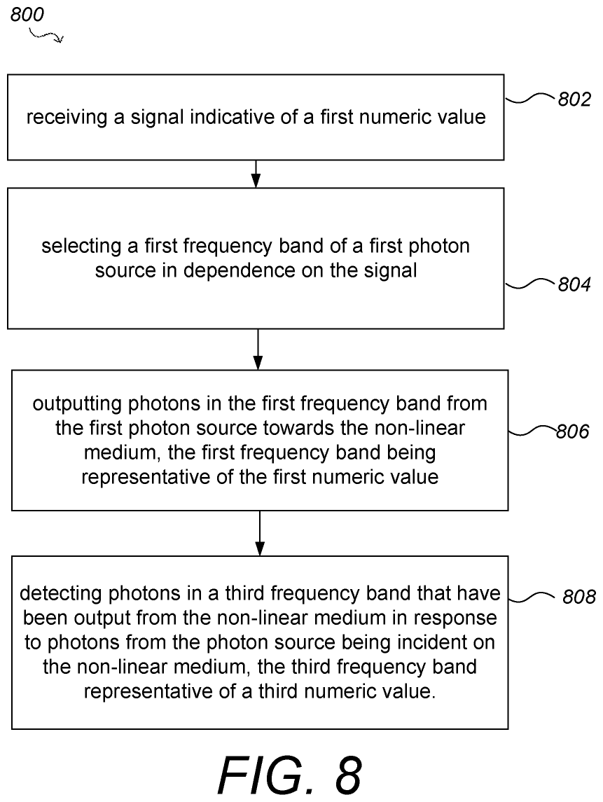

FIG. 8 provides a flowchart of a method 800 for performing arithmetic operations according to an example. The method 800 is for performing arithmetic operations in a predetermined base using the non-linear medium 106. The method may be performed using any apparatus described herein, for example, apparatus 100 of FIG. 1, apparatus 400 of FIG. 4 or apparatus 500 of FIG. 5. The method 800 is for performing arithmetic operations using at least one photon source.

The method 800 comprises receiving 802 a signal 111 indicative of a first numeric value. The method 800 further comprises selecting 804 a first frequency band of a first photon source in dependence on the signal. For example, selecting 804 a first frequency band of a first photon source may comprise selecting 804 a first photon source where a first photon source outputs photons in a first frequency band. The method 800 further comprises outputting 806 photons in the first frequency band from the first photon source towards the non-linear medium 106, the first frequency band being representative of the first numeric value. The method 800 further comprises detecting 808 photons in a third frequency band that have been output from the non-linear medium 106 in response to photons propagated from the photon source being incident on the non-linear medium 106, the third frequency band representative of a third numeric value. The photons incident on the non-linear medium 106 are subject to the non-linear phenomenon of the non-linear medium 106 that performs an arithmetic operation on the first numeric value to generate the third numeric value.

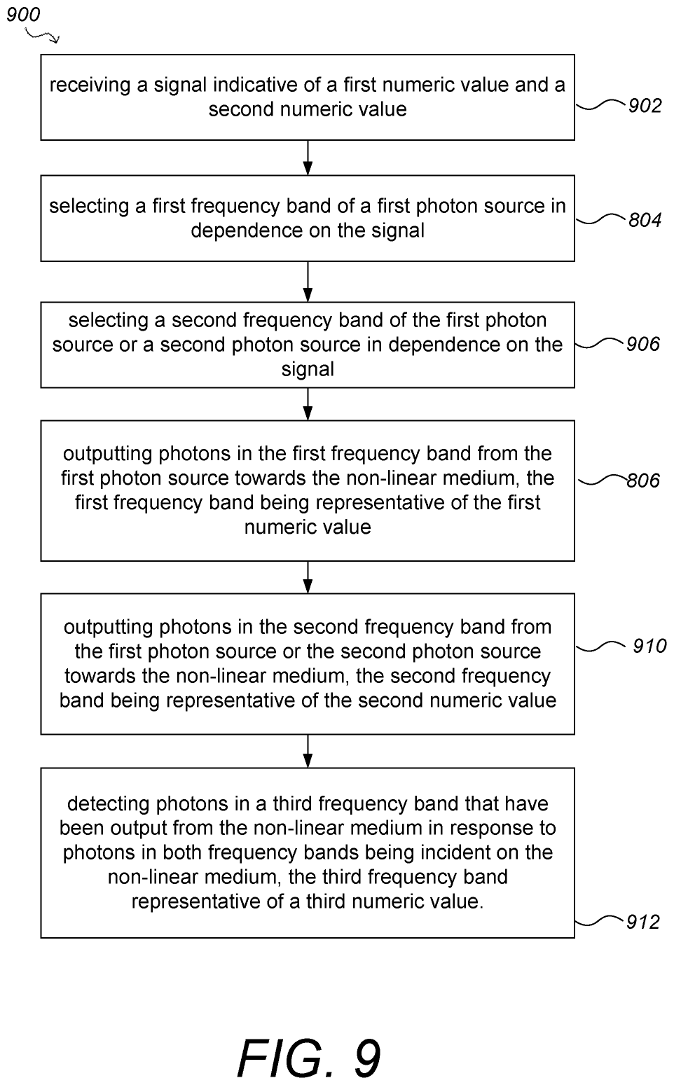

FIG. 9 provides a flowchart of a method 900 for performing arithmetic operations according to another example. The method 900 is for performing arithmetic operations in a predetermined base using the non-linear medium 106. The method 900 is for performing arithmetic operations using one or more photon sources. The method may be performed using any apparatus described herein, for example, apparatus 100 of FIG. 1, apparatus 400 of FIG. 4 or apparatus 500 of FIG. 5.

The method 900 comprises receiving 902 a signal 111 indicative of a first numeric value and a second numeric value. The method 900 further comprises selecting 804 a first frequency band of a first photon source in dependence on the signal, as described in the method 800 of FIG. 8. The method 900 further comprises selecting 906 a second frequency band of the first photon source or a second photon source in dependence on the signal. For example, a second frequency band of the first photon source may be selected when the first photon source is for outputting photons in a first frequency band and a second frequency band towards the non-linear medium. In another example, a second frequency band of the second photon source may be selected when the first photon source is for outputting photons in a first frequency band towards the non-linear medium and the second photon source for outputting photons in a second frequency band towards the non-linear medium. The method 900 further comprises outputting 806 photons in a first frequency band from the first photon source towards the non-linear medium 106, the first frequency band being representative of the first numeric value, as described in the method 800 of FIG. 8. The method 900 further comprises outputting 910 photons in a second frequency band from the first photon source or the second photon source towards the non-linear medium 106, the second frequency band being representative of the second numeric value. The method 900 further comprises detecting 912 photons in a third frequency band that have been output from the non-linear medium 106 in response to photons in both frequency bands, for example, from the first photon source and, optionally, the second photon source being incident on the non-linear medium 106, the third frequency band representative of a third numeric value. In some examples, the photons in the third frequency band may have been output from the non-linear medium 106 in response to photons in three frequency bands being incident on the non-linear medium 106. There may be three photon sources and each photon source may be for outputting photons in a different frequency band of the three frequency bands, or there may be one photon source for outputting photons in all three frequency bands. The photons incident on the non-linear medium 106 may be subject to the non-linear phenomenon of the non-linear medium 106 that performs an arithmetic operation on the first numeric value and the second numeric value to generate the third numeric value. The method may be performed using any number of photon sources. As such, the method 900 may further comprise outputting photons in at least one further frequency band from at least one further photon source towards the non-linear medium 106.

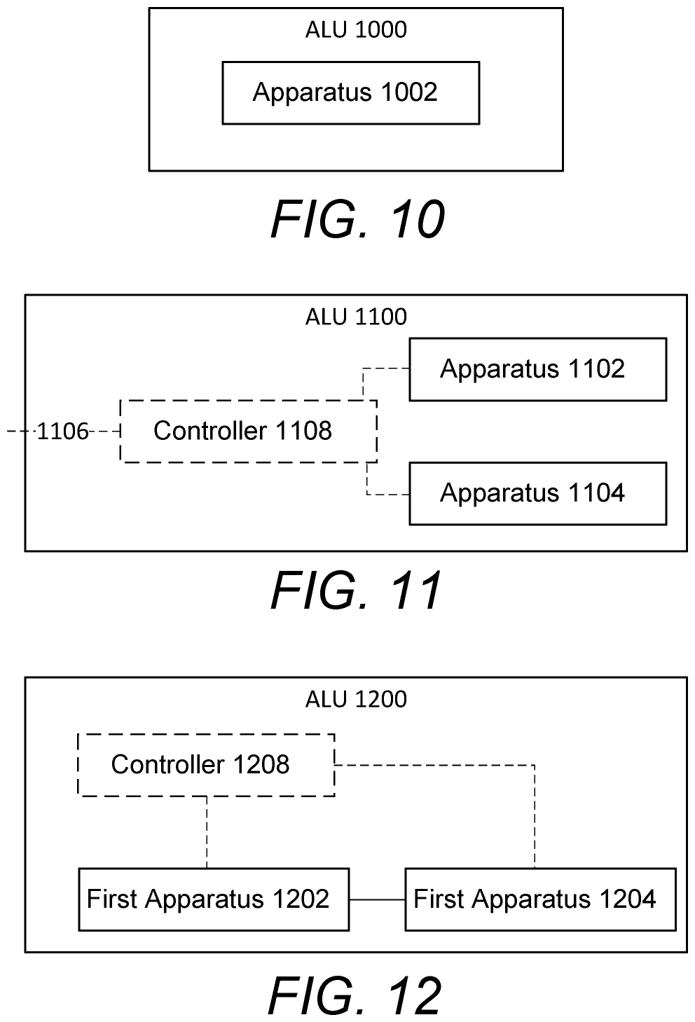

FIG. 10 provides a schematic diagram of an arithmetic logic unit (ALU) 1000 according to an example.

The ALU 1000 may be part a computer processor, or CPU, that carries out arithmetic operations. The ALU 1000 may be instructed to perform particular operations from a control unit (CU) of the CPU. For example, the CU may send data to and receive data from the ALU 1000. The ALU 1000 may also send data to and receive data from input registers of the CPU. The ALU 1000 may perform any of the standard arithmetic operations of addition, subtraction, twos complement, increments (e.g. adding the unit equivalent to “1”), decrement (e.g. subtracting the unit equivalent to “1”), pass through, carry, AND, OR, XOR, ones complement, arithmetic shift, logical shift and rotate. The ALU 1000 may perform any arithmetic operation that the apparatus can perform.

The ALU 1000 comprises apparatus 1002. Apparatus 1002 may be any of the apparatus described herein, for example apparatus 100 of FIG. 1, apparatus 400 of FIG. 4 or apparatus 500 of FIG. 5. Thus, the ALU 1000 performs arithmetic operations utilising photonics. The ALU 1000 may operate in the same base as the apparatus 1002. Therefore, the ALU 1000 may operate in a base of more than two. The ALU 1000 may therefore perform arithmetic operations on any numerical value in any base.

In an example implementation, the ALU 1000 may perform an arithmetic operation using more than one pass through the apparatus 1002. After the first pass through apparatus 1002, the detector 108 may output a photonic or electrical signal indicating the third numeric value from the apparatus 1002. This signal may be sent to a storage area within the CPU and/or may be controlled by a control unit. If multiple arithmetic operations are desired such as multiple additions, the signal output 114 from the detector 108 of the apparatus 1002 may be fed back to the input 112 of the apparatus 1002 for a second pass. For example, where two inputs and a carry need to be added, this means three inputs need to be added. Therefore, in the first pass, two inputs are added as described above and, in the second pass, the output from the first pass and the carry are added, resulting in all three inputs being added. Thus, passing through the apparatus 1002 twice enables three inputs to be added and, since another clock cycle is not required, the CU can continue to fetch and decode the next instruction in line whilst the second pass occurs, meaning the time overall clock speed is not affected. Alternatively, the second pass may be performed by a second apparatus, such that the apparatus are arranged in a cascade configuration, where the output of a first apparatus is input into the second apparatus. The apparatus in a cascade configuration also provide the ability to perform arithmetic operations on more than two numeric values.

The ALU 1000 may be connected to electronic components and so may receive an electrical signal at its input and output an electrical signal. For example, the ALU may be connected to an electronic CU. Thus, the CPU comprising the ALU may be a hybrid electro-photonic CPU. Alternatively, the ALU may be connected to photonic components and so may receive a photonic signal at its input and output a photonic signal. For example, the ALU may be connected to a photonic CU. Thus, the CPU comprising the ALU may be an all-photonic CPU.

FIG. 11 provides a schematic diagram of an ALU 1100 according to another example. The ALU 1100 is an example of ALU 1000 of FIG. 10. ALU 1100 comprises two apparatus 1102, 1104. Each apparatus 1102, 1104 may be any of the apparatus described herein, for example apparatus 100 of FIG. 1, apparatus 400 of FIG. 4 or apparatus 500 of FIG. 5. The apparatus 1102, 1104 may perform these arithmetic operations in the same base. The apparatus 1102, 1104 may be for performing different arithmetic operations. This may be due to photons incident on the non-linear medium 106 of each apparatus 1102, 1104 being subject to a different non-linear phenomenon. For example, apparatus 1102 may perform addition, by the photons incident on the non-linear medium 106 of the apparatus 1102 being subject to Sum Frequency Generation and the apparatus 1104 may perform subtraction, by the photons incident on the non-linear medium 106 of the apparatus 1104 being subject to Difference Frequency Generation.

ALU 1100 may further comprise a controller 1108, illustrated in a dashed line which indicates that the feature is optional. The controller 1108 may receive an input 1106 and send a signal 111 to the input 112 of apparatus 1102 and/or apparatus 1104, as described with reference to FIG. 1. If the apparatus 1102, 1104 are for performing different arithmetic operations, the controller 1108 may determine the arithmetic operation to be performed or may be instructed at its input 1106 to perform a particular arithmetic operation. The controller 1108 may then send an instruction signal to the apparatus 1102, 1104 based on the arithmetic operation. The instruction signal may be a photonic signal or an electrical signal. The controller 1108 may only send an instruction signal to the apparatus 1102, 1104 that is for performing the corresponding arithmetic operation or may send instruction signals to both but only indicating that the apparatus 1102, 1104 that is for performing the corresponding arithmetic operation should output photons based on this instruction signal. The apparatus 1102, 1104 that is for performing the corresponding arithmetic operation may then perform the arithmetic operation. For example, where the apparatus 1102 performs addition and the apparatus 1104 performs subtraction, the controller 1108 may receive an instruction to add two numeric values and so may transmit the instruction signal to the apparatus 1102.

Although ALU 1100 is illustrated as comprising two apparatus 1102, 1104, the ALU 1100 may comprise any number of apparatus. Each apparatus may be connected to the controller 1108. The ALU 1100 may comprise a plurality of apparatus where each apparatus is for performing a different arithmetic operation. For example, if the ALU 1100 supports five different arithmetic operations, the ALU 1100 may comprise five apparatus.

FIG. 12 provides a schematic diagram of an ALU 1200 according to another example. The ALU 1200 is an example of ALU 1000 of FIG. 10 and ALU 1100 of FIG. 11. The ALU 1200 comprises two apparatus 1202, 1204. These may be the same as apparatus 1102, 1104 of ALU 1100 of FIG. 11. The ALU 1200 may comprise controller 1208, which may be controller 1108 of ALU 1100 of FIG. 11.

The apparatus 1202, 1204 of ALU 1200 are connected. Thus, the first apparatus 1202 is used in conjunction with the second apparatus 1204.

FIG. 13 illustrates one way in which the apparatus 1202, 1204 may be connected. FIG. 13 provides an example schematic diagram 1300 of the apparatus 1202, 1204 of the arithmetic logic unit 1200 of FIG. 12. In this configuration, the first apparatus 1202 and second apparatus 1204 may be any apparatus described herein, for example apparatus 100 of FIG. 1, apparatus 400 of FIG. 4 or apparatus 500 of FIG. 5. The first apparatus 1202 and second apparatus 1204 may each further comprise a decomposer 1306 in addition to the non-linear medium 106. A decomposer 1306 is a type of non-linear medium and receives photons at an input frequency and generates photons at two different output frequencies. The sum of the frequencies of the outputs is equivalent to the frequency at the input. Decomposer 1306 may be used when the non-linear phenomenon is Optical Parametric Generation. The non-linear mediums 106 of the apparatus 1202, 1204 subject photons to Sum frequency Generation and so are used for addition. Thus, each of apparatus 1102, 1204 performs two arithmetic operations using two non-linear phenomena.

In the configuration of FIG. 13, the first photon source 102 of the first apparatus 1202 may output photons in a first frequency band ω₁. The decomposer 1306 of the first apparatus 1202 may receive the photons and output photons in a third frequency band ω₃ and a fourth frequency band ω₄. The photons in the fourth frequency band ω₄ are transmitted from the first apparatus 1202 to the second apparatus 1204. The photons in the third frequency band ω₃ are transmitted to the non-linear medium 106 of the first apparatus 1202.

Simultaneously, the second photon source 104 of the second apparatus 1204 may output photons in a second frequency band ω₂. The decomposer 1306 of the second apparatus 1204 may receive the photons and output photons in a fifth frequency band ω₅ and a sixth frequency band ω₆. The photons in the fifth frequency band ω₅ are transmitted from the second apparatus 1204 to the first apparatus 1202. The photons in the sixth frequency band ω₆ are transmitted to the non-linear medium 106 of the second apparatus 1204.

Thus, the non-linear medium 106 of the first apparatus 1202 receives photons in the third frequency band ω₃ and photons in the fifth frequency band ω₅ and outputs photons at a seventh frequency band ω₇ that is the sum of the input frequencies. The non-linear medium 106 of the second apparatus 1204 receives photons in the fourth frequency band ω₄ and photons in the sixth frequency band ω₆ and outputs photons at an eighth frequency band w₈ that is the sum of the input frequencies.

The configuration of the apparatus 1202, 1204 presented in FIG. 13 may be used in the addition of complex numbers. For example, the first frequency band ω₁. may be representative of a first complex number and the second frequency band ω₂ may be representative of a second complex number. Photons having a frequency within the first frequency band ω₁ and photons having a frequency within the second frequency band ω₂ may be split by the decomposers 1306 into photons with frequencies representing the real and imaginary parts of the complex numbers. For example, photons having a frequency within the first frequency band ω₁ may be split by the decomposer 1306 of the first apparatus 1202 into photons having a frequency within the third frequency band ω₃ representative of the real part of the first complex number and photons having a frequency within the fourth frequency band ω₄ representative of the imaginary part of the first complex number. Similarly, photons having a frequency within the second frequency band ω₂ may be split by the decomposer 1306 of the second apparatus 1204 into photons having a frequency within the fifth frequency band ω₅ representative of the real part of the second complex number and photons having a frequency within the sixth frequency band ω₆ representative of the imaginary part of the second complex number. The photons incident on the non-linear medium 106 of the first apparatus 1202 are therefore representative of the real parts of the complex numbers and the photons incident on the non-linear medium 106 of the second apparatus 1204 are therefore representative of the imaginary parts of the complex numbers. The real and imaginary parts of the complex numbers can therefore be summed separately to find the resultant complex number. The non-linear medium 106 of the first apparatus 1202 outputs photons at a seventh frequency band ω₇ that is the sum of the third frequency band ω₃ and the fifth frequency band ω₅ and consequently that is the sum of the real parts of the first complex number and second complex number. The non-linear medium 106 of the second apparatus 1204 outputs photons at an eighth frequency band ω₅ that is the sum of the fourth frequency band ω₄ and the sixth frequency band ω₆ and consequently that is the sum of the imaginary parts of the first complex number and the second complex number. The outputs from the apparatus 1202, 1204 of FIG. 13 therefore provide a complex number (with the real part being provided by the first apparatus and the imaginary part being provided by the second apparatus 1204) that is the sum of the first and second complex numbers input into the apparatus 1202, 1204. Therefore, the ALU 1202 comprising the first and second apparatus 1202, 1204 in the configuration of FIG. 13 can perform addition of complex numbers.

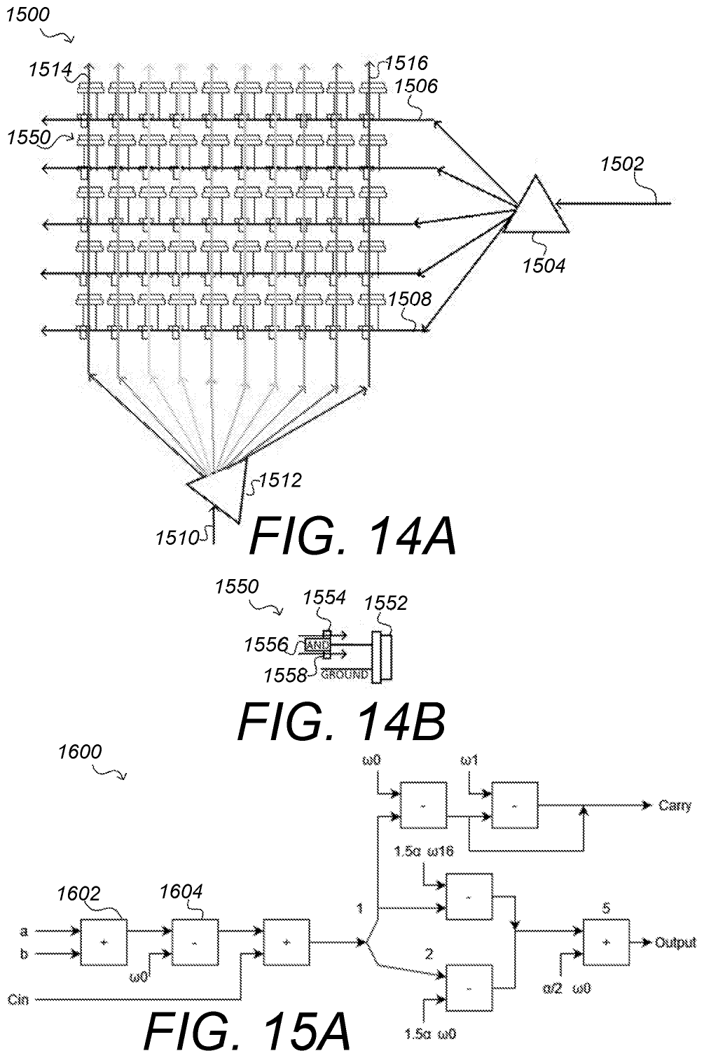

FIGS. 14A and 14B provide schematic diagrams of an example photonic control unit 1500. FIG. 14A provides the schematic diagram of the example photonic control unit 1500 and FIG. 14B provides the schematic diagram of an element 1550 within the photonic control unit 1500. This control unit 1500 is for use with any of the apparatus described herein. The control unit 1500 may be included with the apparatus in a CPU. The control unit may operate as described in relation to FIG. 10. The control unit 1500 can be adapted to be used with any base and therefore the combination of the control unit and the apparatus as described herein is advantageous as it enables bases of higher than two to be used which provides a more efficient and faster processor.

The photonic control unit 1500 shown in FIG. 14A comprises two prisms 1504, 1512 and a grid of photonic elements 1550, which are illustrated in FIG. 14B. Each photonic element 1550 comprises a diode 1552, an AND gate 1556 and two photonic sensors 1554, 1558. In the photonic control unit 1500, two inputs are provided, an instruction beam 1502 and a numerical value beam 1510. The photonic elements 1550 form a grid where each row 1506, 1508 represents an instruction and each column 1514, 1516 represents the corresponding output for that instruction at different wavelengths. Whilst five rows and ten columns are shown in the figure, the photonic control unit 1500 may comprise any number of rows and columns. The instruction beam 1502 is input into a first prism 1504 and the instruction is refracted into the row representing that instruction. The instruction may indicate a particular arithmetic operation. The numerical value beam 1510 is input into a second prism 1512 and refracts into the column representing that numerical value. The refraction of the instruction beam 1502 and numerical value beam 1510 may be due to the wavelength of the beams, which is a characteristic of each beam. The row and column with the refracted beams intersect at the relevant element causing light to be incident on both photonic sensors 1554, 1558. The photonic sensors 1554, 1558 may be photoresistors that convert a change of incident light into a change of resistance allowing current to pass and thus enabling a high output to be input into the AND gate 1556 when the light changes. When the AND gate 1556 receives a high output from both photonic sensors, it outputs a voltage (indicating a “1”). This powers the diode 1552 which generates a single output beam at a particular frequency. This output from the element therefore corresponds to the numerical value and instruction. If there is more than one numerical value, then the refracted beam in the row interacts with refracted beams in the plurality of columns resulting in multiple intersections and consequently multiple elements generating and outputting beams relevant to the numerical values and instruction. The output from the diode(s) may then be sent to the input 112 of an apparatus described herein. For example, where the instruction indicates the arithmetic operation of addition, the output of the photonic control unit may be sent to the input 112 of an adder as described herein.

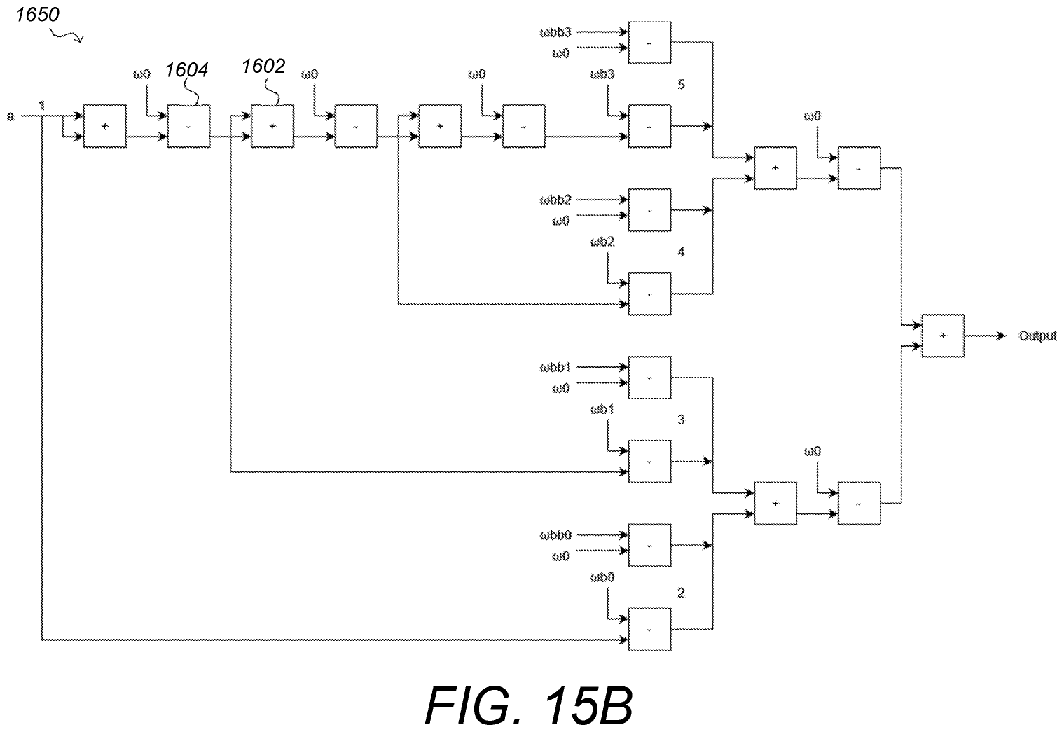

FIG. 15A illustrates an example full adder 1600 comprising one or more of the apparatus described herein, for example apparatus 100 of FIG. 1, apparatus 400 of FIG. 4 or apparatus 500 of FIG. 5. The full adder 1600 may comprise a plurality of non-linear media 1602, labelled with a “+”, used for SFG and a plurality of non-linear media 1604, labelled with a “−”, used for DFG. The lines connecting each component may be waveguides. The adder 1600 may be a single pass full adder. The adder 1600 operates in the base of 16 and so is a hexadecimal adder. Chaining the adder 1600 together 16 times enables the creation of a 64-bit full adder that operates in a single pass.

The adder 1600 performs an addition of two numeric values with a value of 0 to 15, each numeric value represented by a photon frequency or frequency band. The adder 1600 has three variable inputs: the two numeric values to sum are represented by A and B, and the carry input is labelled Cin. Three constants are also input to the system, labelled ω0, ω1 and ω16, which correspond to the frequencies representing the numeric values 0, 1 and 16 respectively. Thus, the adder 1600 may comprise a single photon source outputting photons in six different frequency bands, each frequency band representative of one of the inputs or the adder 1600 may comprise six photon sources, each photon source for outputting photons in a different frequency band, each frequency band representative of one of the inputs. Any of the inputs may be split using, for example, optical splitters.

The photons with frequencies representing numeric values A and B are input into a first SFG medium 1602 to sum the numeric values. The output of this SFG medium 1602 is input into a DFG medium 1604 which also receives input ω0. The purpose of this medium is to reduce the frequency of the photons into the 1500 nm range (effectively shifting the sum of the numeric values back into the original bandwidth) because if another addition was performed this would cause the wavelength of the photons to reach around 300 nm which is absorbed by silicon. The output of the DFG medium 1604 is input into another SFG medium 1602 to add the reduced sum of A and B to the carry input Cin to produce the sum of A, B and Cin. The full adder 1600 may comprise a splitter, such as a prism, that routes photons representing the sum of A, B and Cin up to point 1 if the photon frequency representing the sum of A, B and C is greater than 15, or routes it down to point 2 if it represents less than or equal to 15.

At point 2, the value is shifted in frequency band by the value of ω0 that lies in the bandwidth of 1.5 alpha (where alpha is the original input frequency bandwidth). This is then summed at point 5 with the ω0 that lies within ω/2 to produce a result that is in the alpha bandwidth. At point 1, the value is split, where one split undergoes a DFG with the values of ω16 that lies in 1.5 alpha. The result is then added to the same DFG medium above at point 5. The other split is passed into a DFG with ω0, such that if a value is present, ω0 is not passed. If a value is not present then ω0 is passed. Another DFG medium accepts the result such that if ω0 is passed, then this cancels the value of ω₁ (and if there is no result then ω₁ is passed). This produces a carry of either 0 or 1 depending on the presence of a value at point 1. The output of the DFG medium at point 5 provides the main output.

FIG. 15B illustrates an example multiplier 1650 comprising one or more of the apparatus described herein, for example apparatus 100 of FIG. 1, apparatus 400 of FIG. 4 or apparatus 500 of FIG. 5. The multiplier 1650 may comprise a plurality of non-linear media 1602, labelled with a “+”, used for SFG and a plurality of non-linear media 1604, labelled with a “−”, used for DFG. The multiplier 1650 may be a single pass multiplier. The multiplier 1650 may operate in the base of 16 and so may be a hexadecimal multiplier. The multiplier 1650 operates as follows.

Data A and data B are passed into the system as the two variables to multiply together along with a carry. Both of these values are in base 16. They take the form of photons of a single frequency selected from a set of 16 distinct frequencies. The set of 16 frequencies represent the values 0 to 15. A constant ω0 is also input to the system, where photons input at ω0 have a frequency that represents the number 0. Thus, the multiplier 1650 may comprise a single photon source outputting photons in three different frequency bands, each frequency band representative of one of the inputs. Alternatively, the multiplier 1650 may comprise three photon sources, each outputting photons in a different frequency band, each frequency band representative of one of the inputs.

Data A is split at point 1, where one side is doubled, and the other is passed to point 2. After doubling, A is split again and passed to point 3, the other split is doubled once again. This is repeated and A is passed to points 4 and 5 accordingly. Data B is passed into a demultiplexer (not shown), where it is split into its according bit values, along with a secondary “not” value. Each bit value is passed along to points 2, 3, 4 and 5 respectively. At each point, b is passed into a DFG with the value of a at this point, while bb (the secondary not value) is passed into another DFG with ω0. If the bit value of b is present at a DFG, it will pass the value of either ω0 or a at this point. This is repeated at all of points 2, 3, 4 and 5. The resulting value of each point is them summed and the answer is output. The output may be incident on one or more detectors, such as photodiodes, to read the result. Chaining the multiplier 1650 together 16 times can create a 64-bit single pass multiplier.

The single pass adder and multiplier are advantageous as they enable more complex algorithms in single pass architectures. Electronics currently takes hundreds of clock cycles to complete a single hash of SHA-256, therefore reducing this to a single cycle would increase compute efficiency dramatically. The latency of completing a hash would also be greatly reduced, as it would be operated by a single set of modulations that do not need to be tuned during computation. Performing addition and multiplication in a single pass also advantageously reduces the power consumption.

In particular, multiplication in the electrical domain takes multiple cycles using state of the art electronics and increases in time complexity as you increase the bit width of the multiplication. The multiplier 1650 provides a single-pass multiply in the optical domain i.e. multiplication in a single cycle. This reduces both the latency of multiplication and the cycles to complete multiplication.

The ALU 1000 has been tested using the following experimental setup to produce the following results.

A fibre optic prototype ALU with a base of 8 was set up using optical fiber connections. The base of 8 was chosen because 8 bits is divisible into 64, meaning that 64-bit words can be split into bytes to process them individually. Eight photon sources were included within the ALU. A program to iterate through every combination of possible additions of individual numbers was created and connected to the ALU. This program had every number from 0-255 summed with every other number in the same set and saved the output from the ALU to a file, along with the expected outcome and error rates.

The iteration program created was driven by a Raspberry Pi™ computer. To ensure that the results were not being performed by the computer itself, a secondary computer was attached to the first computer to accept only the outputs of the ALU. The complete system had a computer iterating through all inputs, and pushing them to the photonics of the ALU, with a second computer accepting the photonic output and comparing the result with the expected result. For the secondary computer to understand the expected result and compare against the received result, a defined order of inputs were set. For the output computer to be able to interpret a single result, a data rate was also established. For testing purposes, this data rate was set to a value being pushed every 0.1 milliseconds.

The output computer stored the results for all the iterations read by the system. Once the iterations were completed, the actual results were compared with the expected results. An error rate was generated from this comparison. The table below shows a sample CSV output of expected results and actual results and the error rate, which is shown as 0%.

| | Input | Input | Expected | Actual | | Error |
|---|---|---|---|---|---|---|
| Operation | 1 | 2 | Out | Out | Correct | Rate |
| 1 | 0 | 0 | 0 | 0 | Yes | 0 |
| 2 | 0 | 1 | 1 | 1 | Yes | 0 |
| 3 | 0 | 2 | 2 | 2 | Yes | 0 |
| 4 | 0 | 3 | 3 | 3 | Yes | 0 |
| 5 | 0 | 4 | 4 | 4 | Yes | 0 |
| 6 | 0 | 5 | 5 | 5 | Yes | 0 |
| 7 | 0 | 6 | 6 | 6 | Yes | 0 |
| 8 | 0 | 7 | 7 | 7 | Yes | 0 |
| 9 | 0 | 8 | 8 | 8 | Yes | 0 |
| 10 | 0 | 9 | 9 | 9 | Yes | 0 |

The program was also run over larger scales of iterations (100 iterations, which is over 6,500,000 results) of all possible combinations of additions and still provided a 0% error rate. This gives confidence that the system has an accuracy rate that can keep up with the demands of an electronic CPU.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An apparatus for performing arithmetic operations in a predetermined base, the apparatus comprising:
a non-linear medium;
one or more photon sources for outputting photons in a first frequency band and a second frequency band towards the non-linear medium, the first frequency band being representative of a first numeric value and the second frequency band being representative of a second numeric value;
an input to receive a signal indicative of at least one numeric value,
logic to select at least one of the first frequency band and second frequency band in dependence on the signal; and
a detector configured to detect photons in a third frequency band that have been output from the non-linear medium in response to photons from at least one of the one or more photon sources in the at least one of the first frequency band and second frequency band being incident on the non-linear medium, the third frequency band representative of a third numeric value,
wherein the photons incident on the non-linear medium are subject to the non-linear phenomenon of the non-linear medium to perform an arithmetic operation on one or both of the first numeric value and the second numeric value to generate the third numeric value.

2. An apparatus according to claim 1, wherein the first and second frequency bands are different and the first and second numeric values are different.

3. An apparatus according to claim 1 or claim 2, wherein at least one of the one or more photon sources are configured to output photons in response to selection by the logic.

4. An apparatus according to any preceding claim, wherein the detector is configured to output an electrical signal representative of the third numeric value.

5. An apparatus according to any preceding claim, wherein the one or more photon sources comprise a first photon source for outputting photons in a first frequency band towards the non-linear medium and a second photon source for outputting photons in a second frequency band towards the non-linear medium.

6. An apparatus according to claim 5, wherein the logic is to select at least one of the first and second photon sources in dependence on the signal.

7. An apparatus according to claim 5 or claim 6, wherein the number of photon sources selected by the logic to output photons is based on the arithmetic operation.

8. An apparatus according to any of claims 5 to 7, wherein the number of photon sources in the apparatus corresponds to the base of the arithmetic operations.

9. An apparatus according to any of claims 5 to 8, wherein the photons output by the first photon source and the second photon source towards the non-linear medium are combined into a single beam that is incident on the non-linear medium.

10. An apparatus according to any of claims 5 to 9, wherein the apparatus comprises at least one further photon source, each photon source for outputting photons in a different respective frequency band representative of a different numeric value towards the non-linear medium,
wherein the signal is indicative of a further numeric value,
wherein the logic is further configured to select a further photon source of the at least one further photon source based on the signal, and
wherein the further photon source is configured to output photons in response to selection by the logic.

11. An apparatus according to any of claims 5 to 10, wherein the apparatus further comprises a controller comprising the input and the logic, the controller configured to output one or more selection signals to only the one or more photon sources with output frequency bands corresponding to the at least one numeric value to output photons based on the logic.

12. An apparatus according to claim 11, wherein the input of the controller is configured to receive an electrical signal or a photonic signal indicating at least one numeric value to perform the arithmetic operation on.

13. An apparatus according to claim 11 or claim 12, wherein the one or more selection signals are electrical signals or photonic signals.

14. An apparatus according to any of claims 5 to 13, wherein the apparatus comprises a further photon source for outputting photons in a further frequency band different from the first and second frequency bands towards the non-linear medium, the further frequency band being representative of a fourth numeric value,
wherein the photons incident on the non-linear medium are subject to the non-linear phenomenon of the non-linear medium to perform an arithmetic operation on the fourth numeric value and one or both of the first and second numeric values to generate the third numeric value.

15. An apparatus according to any of claims 5 to 14, wherein the first photon source is further configured to output photons in a further frequency band different from the first and second frequency bands, the further frequency band being representative of a fourth numeric value, and
wherein the logic is to select one of the first frequency band and further frequency band of the first photon source.

16. An apparatus according to claim 15, wherein the second photon source is further configured to output photons in a second further frequency band different from the first, second and further frequency bands, the second further frequency band being representative of a fifth numeric value, and
wherein the logic is to select one of the second frequency band and second further frequency band of the second photon source.

17. An apparatus according to claim 16, wherein the logic is to select the frequency band of the first and second photon sources based on the numeric values required to perform the arithmetic operation.

18. An apparatus according to any of claims 15 to 17, wherein the first frequency band and further frequency band of the first photon source do not overlap and wherein the second frequency band and the second further frequency band of the second photon source do not overlap.

19. An apparatus according to any of claims 1 to 4, wherein the one or more photon sources comprise a first photon source for outputting photons in a first frequency band and a second frequency band towards the non-linear medium.

20. An apparatus according to claim 19, wherein the number of frequency bands selected by the logic is based on the arithmetic operation.

21. An apparatus according to claim 19 or claim 20, wherein the first photon source is for outputting photons in a number of frequency bands corresponding to the base of the arithmetic operations.

22. An apparatus according to any one of claims 19 to 21, wherein the photons output by the first photon source are in a single beam that is incident on the non-linear medium.

23. An apparatus according to any preceding claim, wherein the non-linear medium is birefringent crystal.

24. An apparatus according to any preceding claim, wherein each photon source is a laser diode.

25. An apparatus according to any preceding claim, wherein the frequency bands of the one or more photon sources do not overlap.

26. An apparatus according to any preceding claim, wherein the majority of photons output in each frequency band are at a single frequency within the frequency band.

27. An apparatus according to any preceding claim, the apparatus further comprising a filter configured to receive the photons output from the non-linear medium and to filter the photons such that only photons having a frequency within the third frequency band propagate through the filter to the detector.

28. An apparatus according to any preceding claim, wherein the arithmetic operation is one of adding, subtracting, multiplying, dividing, shifting, a logical operation and bit manipulation.

29. An apparatus according to any preceding claim, wherein the arithmetic operation is in a base of more than two.

30. An apparatus according to any preceding claim, wherein if the third numeric value is above the maximum numeric value allowable by the base, a carry bit attached to the third numeric value is set.

31. An apparatus according to any preceding claim, wherein the arithmetic operation is addition and wherein the non-linear phenomenon is sum frequency generation.

32. An arithmetic logic unit, ALU, comprising one or more apparatus according to any preceding claim.

33. An ALU according to claim 32, wherein at least two apparatus of the one or more apparatus are for performing different arithmetic operations, and
wherein the signal received at the input of each apparatus is based on the type of arithmetic operation and the at least one numeric value.

34. An ALU according to claim 33, the ALU comprising a controller configured to:
receive at least one instruction signal indicating the type of arithmetic operation to be performed and the at least one numeric value to perform the arithmetic operation on; and
output a signal to only the apparatus for performing the type of arithmetic operation.

35. An ALU according to claim 34, wherein the instruction signal is an electrical signal or a photonic signal.

36. An ALU according to any of claims 32 to 35, wherein two apparatus for performing the same arithmetic operation are arranged in a cascade configuration such that the first photon source of the second apparatus is configured to output photons in the third frequency band representative of the third numeric value output from the first apparatus and the first photon source or the second photon source of the second apparatus is configured to output photons in a further frequency band representative of a fourth numeric value such that the arithmetic operation is performed on the fourth numeric value and one or both of the first and second numeric values.

37. A method for performing arithmetic operations in a predetermined base using a non-linear medium, the method comprising:
receiving a signal indicative of a first numeric value;
selecting a first frequency band of a first photon source in dependence on the signal;
outputting photons in the first frequency band from the first photon source towards the non-linear medium, the first frequency band being representative of the first numeric value; and
detecting photons in a third frequency band that have been output from the non-linear medium in response to photons from the photon source being incident on the non-linear medium, the third frequency band representative of a third numeric value,
wherein the photons incident on the non-linear medium are subject to the non-linear phenomenon of the non-linear medium that performs an arithmetic operation on the first numeric value to generate the third numeric value.

38. A method according to claim 37, wherein the signal is further indicative of a second numeric value, the method further comprising:
selecting a second frequency band of the first photon source or a second photon source in dependence on the signal;
outputting photons in the second frequency band from the first photon source or the second photon source towards the non-linear medium, the second frequency band being representative of the second numeric value; and
detecting photons in a third frequency band that have been output from the non-linear medium in response to photons in both frequency bands being incident on the non-linear medium,
wherein the photons incident on the non-linear medium are subject to the non-linear phenomenon of the non-linear medium that performs an arithmetic operation on the first numeric value and the second numeric value to generate the third numeric value.

39. A photonic control unit, the photonic control unit comprising:
a two-dimensional array of photonic elements having at least two rows and at least two columns;
a first refractor for receiving an instruction beam indicating an instruction and refracting the instruction beam into at least one row of the at least two rows based on a characteristic of the instruction beam;
a second refractor for receiving a numeric value beam indicating a numeric value and refracting the numeric value beam into at least one column of the at least two columns based on a characteristic of the numeric value beam,
wherein the instruction beam and numeric value beam intersect at at least one photonic element, causing the photonic element to output a control signal indicating the instruction and the numeric value.

40. A system comprising an ALU according to any of claims 32 to 36 and a photonic control unit according to claim 39.
